(19) United States
(12) Patent Application Publication
(10) Pub. No.: US 2010/0310147 A1
(43) Pub. Date: Dec. 9, 2010

(54) DATA TRANSFER SYSTEM, TRANSMITTING APPARATUS, RECEIVING APPARATUS, RADIOGRAPHIC IMAGE TRANSFER SYSTEM, AND RADIOGRAPHIC IMAGE DIAGNOSIS SYSTEM

(75) Inventor: Yukio SUGITA, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: FUJIFILM CORPORATION, Tokyo (JP)

(21) Appl. No.: 12/777,043

(22) Filed: May 10, 2010

(30) Foreign Application Priority Data
Jun. 3, 2009 (JP) 2009-134276

(51) Int. Cl. G06K 9/62; G06F 13/12

(52) U.S. Cl. 382/132; 710/68

(57) ABSTRACT

A data transfer system capable of avoiding slowdown of processing while protecting contents of data to be transmitted is provided. The data transfer system includes a transmitting apparatus that transmits data and a receiving apparatus that receives the transmitted data. The transmitting apparatus includes: an encoding section supplied with to-be-converted data, converts the data into a code by using a correspondence table in which one-to-one correspondence between data values and codes is described and generates encoded data; a replacement table generating section that, for at least a part of the correspondence described in the correspondence table used by the encoding section, replaces a corresponding counterpart with another counterpart included in the correspondence, and generates a replacement table; and a transmitting section that transmits a group of data in which the encoded data generated by the encoding section and the replacement table generated by the replacement table generating section are combined.

### TECHNICAL FIELD

The present invention relates to a data transfer system, a transmitting apparatus, a receiving apparatus, a radiographic image transfer system, and a radiographic image diagnosis system.

### BACKGROUND ART

A data transfer system that encodes data and transmits the data from a transmitting apparatus and receives the data by a receiving apparatus and decodes and utilizes the data is employed in various types of apparatuses.

For example, in a radiographic image diagnosis system used for diagnosis of disease, a subject as a target for diagnosis is subjected to radiation from a radiation source, and the radiation after passing through the subject is emitted to a fluorescent body in a detection panel unit. In the detection panel unit, an image generated by the light emission of the fluorescent body is electrically read, so that image data of the subject after passing through radiation is obtained. The image data is transferred from the detection panel unit to a system controller in the radiographic image diagnosis system, and displaying an image and image processing for diagnosis are performed to be used for diagnosis.

In the radiographic image diagnosis system, data transfer is expected to be performed via wireless communications to enhance transportability of the system. In order to perform the data transfer wirelessly, it is conceivable to compress image data by encoding the image data on a transmitting apparatus side and decoding it on a receiving apparatus side, thereby reducing the amount of transferring data. Also, when transferring data wirelessly, enhancement of protection against the leakage of personal information is required. Here, a generation method of encoding image data that encrypts image data to be transmitted is known (see, for example, Japanese Patent Application Publication No. H10-108180).

However, in a conventional image encryption apparatus, the image encryption imposes heavy load, probably resulting in slowdown of processing. This problem is not only limited to a radiographic image diagnosis system, but also common to a system in which encoded data is transferred.

In view of the above circumstances, it is an object according to aspect of the present invention to provide a data transfer system, a transmitting apparatus, a receiving apparatus, a radiographic image transfer system, and a radiographic image diagnosis system which address the problems and in which contents of data to be transmitted are protected while avoiding slowdown of processing.

### DISCLOSURE OF INVENTION

According to a first aspect of the invention, data transfer system includes:
a transmitting apparatus that transmits data; and
a receiving apparatus that receives the data transmitted by the transmitting apparatus,
wherein the transmitting apparatus comprises:
   an encoding section that is supplied with to-be-converted data, converts the data into a code by using a correspondence table in which one-to-one correspondence between a plurality of data values and a plurality of codes is described and generates encoded data;
   a replacement table generating section that, for at least a part of the correspondence described in the correspondence table used by the encoding section, replaces a corresponding counterpart with another counterpart included in the correspondence, and generates a replacement table; and
   a transmitting section that transmits a group of data in which the encoded data generated by the encoding section and the replacement table generated by the replacement table generating section are combined, and wherein the receiving apparatus comprises:
   a receiving section that receives the group of data transmitted by the transmitting section;
   a re-replacement table generating section into which a replacement rule for replacing a corresponding counterpart in one-to-one correspondence between a plurality of data values and a plurality of codes with another counterpart included in the correspondence is inputted, and which replaces, according to the replacement rule, the corresponding counterpart in the correspondence described in the replacement table in the group of data received by the receiving section, and generates a re-replacement table; and
   a decoding section that decodes the encoded data in the group of data received by the receiving section to a data value by using the re-replacement table generated by the re-replacement table generating section.

In the data transfer system according to the first aspect of the invention, a replacement table that is different from the correspondence table used for encoding is transferred. Therefore, when encoding is simply performed based on this replacement table, the data is not restored to a state before the encoding, so that even if an outsider receives a group of data, its contents would not be understood. If a person who knows that a replacement rule is correct inputs the correct replacement rule into the re-replacement table generating section, the data is restored to the state before the encoding. In other words, the replacement rule may be used as an encryption key. Furthermore, since the replacement table is generated by replacing a corresponding counterpart with another counterpart included in the correspondence for at least a part of the correspondence described in the correspondence table, processing for encryption is simple. Therefore, it is possible to avoid slowdown of processing necessary for transferring while protecting contents of data to be transferred.

In the data transfer system according to the first aspect of the invention, it is preferable that the re-replacement table generating section replaces the corresponding counterpart with the another counterpart for a portion in which a frequency of access for reference at the time of conversion is lower than that in another portion, in the correspondence described in a correspondence table used by the encoding section, and generates a replacement table.

When the encoded data is decoded by the replacement table in which a portion having a lower frequency of access for reference is replaced, the data is restored unevenly to such an extent that, if the data is a type of contents represented by the data, for example, radiographic image data, the data is restored in such a degree that the image is determined as a radiographic image of the chest. On the other hand, if decoding is performed by a re-replacement table generated by using a correct replacement rule, the data is restored clarity such that details in the contents represented by the data, for example, a sick portion in the radiographic image of the chest is determined. Therefore, for example, an outline of data is made readable for an outside while detailed contents relating to personal information is protected, and it is possible to readily handle the data.

In the data transfer system according to the first aspect of the invention, it is preferable that the transmitting apparatus comprises a compression section which compresses data, the compression section either including the encoding section or being separate from the encoding section.

Since the data to be transferred is compressed, transferring time may be reduced. Also selection options of means of transferring data are decompressed, for example, wireless and the like.

In the data transfer system according to the first aspect of the invention, it is preferable that the transmitting apparatus further comprises:
a differential generating section that determines a difference between numeric values adjacent to each other directly or with a certain space therebetween, for consecutive numeric values of to-be-compressed data made up of consecutive numeric values, and generates new to-be-compressed data made up of consecutive numeric values each representing the difference;
an offset section that offsets each numeric value of the new to-be-compressed data generated by the differential degeneration section by a predetermined value;
a division section that divides each of numeric values of the to-be-compressed data which are offset by the offset section into a higher-order bit portion and a lower-order bit portion, at a predetermined division bit number smaller than the predetermined unit bit number, so as to divide the to-be-compressed data into higher-order data made up of a series of the higher-order bit portions of the respective numeric values and lower-order data made up of a series of the higher-order bit portions of the respective numeric values; and
a higher-order-data compression section that subjects the higher-order data obtained as a result of the division by the division section to reversible compression processing, and
the encoding section plays a role of at least a part of the reversible compression processing in the higher-order-data compression section.

Since the numeric value representing a difference is offset by a predetermined value and divided into the higher-order bit portion and the lower-order bit portion, and reversible processing is applied to the higher-order bit portion, it is possible to effectively compress the higher-order bit portion where values tend to be unevenly distributed. Moreover, utilizing the encoding in the higher-order bit portion enables effective encryption.

In the data transfer system according to the first aspect of the invention, it is preferable that the higher-order-data compression section further comprises a consecutive encoding section that directly outputs, with respect to numeric values except one or a plurality of predetermined to-be-compressed numeric values in the higher-order data, the numeric values as they are, and that encodes, with respect to the to-be-compressed numeric value, the to-be-compressed numeric values to the to-be-compressed numeric value and a numeric value representing the number of consecutive pieces of a to-be-compressed numeric value that is identical to the to-be-compressed numeric value to be outputted, and
the encoding section is an entropy encoding section that subjects the data after being encoded in the consecutive encoding section to entropy encoding by using the correspondence table.

As provided with the consecutive encoding section, further improvement of the compression ratio by the entropy encoding is expected.

In the data transfer system according to the first aspect of the invention, it is preferable that the higher-order-data compression section further comprises a consecutive encoding section that directly outputs, with respect to numeric values except one or a plurality of predetermined to-be-compressed numeric values in the higher-order data, the numeric values as they are, and that encodes, with respect to the to-be-compressed numeric value, the to-be-compressed numeric values to the to-be-compressed numeric value and a numeric value representing the number of consecutive pieces of a to-be-compressed numeric value that is identical to the to-be-compressed numeric value to be outputted, and
the encoding section is a Huffman encoding section that subjects the data after being encoded in the consecutive encoding section to Huffman encoding by using a Huffman table as the correspondence table.

As provided with the consecutive encoding section, further improvement of the compression ratio by the entropy encoding is expected.

In the data transfer system according to the first aspect of the invention, it is preferable that the higher-order-data compression section further comprises:
a consecutive encoding section that directly outputs, with respect to numeric values except one or a plurality of predetermined to-be-compressed numeric values in the higher-order data, the numeric values as they are, and that encodes, with respect to the to-be-compressed numeric value, the to-be-compressed numeric values to the to-be-compressed numeric value and a numeric value representing the number of consecutive pieces of a to-be-compressed numeric value that is identical to the to-be-compressed numeric value to be outputted;
a histogram calculation section that obtains a histogram of a numeric value which occurs in the data after being encoded in the consecutive encoding section; and
a code assignment section that allocates, in a table which associates a code with a numeric value, the code having a shorter code length for the numeric value having a higher frequency of occurrence, based on the histogram obtained by the histogram calculation section, and
the encoding section is an entropy encoding section that subjects the data after being encoded in the consecutive encoding section to entropy encoding by using the table in which the code is allocated in the code assignment section as the correspondence table.

In this case, in comparison with the entropy encoding using a table in which assignment of codes is fixed, it is possible to further improve the compression ratio.

In the data transfer system according to the first aspect of the invention, it is preferable that the transmitting apparatus further comprises a lower-order-data compression section that subjects the lower-order data divided by the division section to reversible compression processing, and
the encoding section plays a role of at least a part of the reversible compression processing in the lower-order-data compression section.

In the data transfer system according to the first aspect of the invention, it is preferable that the encoding section subjects the lower-order data to entropy coding by using the correspondence table.

In the data transfer system according to the first aspect of the invention, it is preferable that the encoding section subjects the lower-order data to Huffman encoding by using a Huffman table as the correspondence table.

In the data transfer system according to the first aspect of the invention, it is preferable that the lower-order-data compression section outputs the lower-order data without compression in respond to an instruction to omit compression.

According to a second aspect of the invention, a transmitting apparatus includes:
an encoding section that is supplied with to-be-converted data, converts the data into a code by using a correspondence table in which one-to-one correspondence between a plurality of data values and a plurality of codes is described and generates encoded data;
a replacement table generating section that, for at least a part of the correspondence described in the correspondence table used by the encoding section, replaces a corresponding counterpart with another counterpart included in the correspondence, and generates a replacement table; and
a transmitting section that transmits a group of data in which the encoded data generated by the encoding section and the replacement table generated by the replacement table generating section are combined.

The transmitting apparatus according to the second aspect of the invention makes it possible to protect contents of data to be transferred while avoiding slowdown of processing necessary for transfer.

According to a third aspect of the invention, a receiving apparatus includes:
a receiving section that receives a group of data in which a correspondence table where one-to-one correspondence between a plurality of data values and a plurality of codes is described and encoded data of a series of the codes are combined;
a receiving-side re-replacement table generating section into which a replacement rule for replacing a corresponding counterpart in the one-to-one correspondence between a plurality of data values and a plurality of codes with another counterpart included in the correspondence is inputted, and which replaces, according to the replacement rule, the corresponding counterpart in the correspondence described in the replacement table in the group of data received by the receiving section, and generates a receiving-side re-replacement table; and
a decoding section that decodes the encoded data in the group of data received by the receiving section to a data value by using the receiving-side re-replacement table generated by the receiving-side re-replacement table generating section.

The receiving apparatus according to the third aspect of the invention makes it possible to protect contents of data to be transferred while avoiding slowdown of processing necessary for transfer.

According to a fourth aspect of the invention, a radiographic image transfer system includes:
a radiation detection unit that receives radiation emitted from a radiation source and passing through a to-be-diagnosed subject and transmits data representing an image by the radiation; and
a data receiving unit that receives the data transmitted from the radiation detection unit and performs processing,
wherein the radiation detection unit comprises: an encoding section that is supplied with to-be-converted data, converts the data into a code by using a correspondence table in which one-to-one correspondence between a plurality of data values and a plurality of codes is described, and generates encoded data;
a replacement table generating section that, for at least a part of the correspondence described in the correspondence table used by the encoding section, replaces a corresponding counterpart with another counterpart included in the correspondence, and generates a replacement table; and
a transmitting section that transmits a group of data in which the encoded data generated by the encoding section and the replacement table generated by the replacement table generating section are combined, and
wherein the data receiving unit comprises:
a receiving section that receives the group of data transmitted by the transmitting section;
a re-replacement table generating section into which a replacement rule for replacing a corresponding counterpart in one-to-one correspondence between a plurality of data values and a plurality of codes with another counterpart included in the correspondence is inputted, and which replaces, according to the replacement rule, the corresponding counterpart in the correspondence described in the replacement table in the group of data received by the receiving section, with another counterpart, thereby generating a re-replacement table; and
a decoding section that decodes the encoded data in the group of data received by the receiving section to a data value by using the re-replacement table generated by the re-replacement table generating section.

According to a fifth aspect of the invention, a radiographic image diagnosis system includes:
a radiation detection unit that receives radiation emitted from a radiation source and passing through a to-be-diagnosed subject and transmits data representing an image by the radiation; and
a data processing unit that receives the data transmitted from the radiation detection unit and performs processing for diagnosis,
wherein the radiation detection unit comprises:
an encoding section that is supplied with to-be-converted data and converts the data into a code by using a correspondence table in which one-to-one correspondence between a plurality of data values and a plurality of codes is described, thereby generating encoded data;
a replacement table generating section that, for at least a part of the correspondence described in the correspondence table used by the encoding section, replaces a corresponding counterpart with another counterpart included in the correspondence, and generates a replacement table; and
a transmitting section that transmits a group of data in which the encoded data generated by the encoding section and the replacement table generated by the replacement table generating section are combined, and
wherein the data receiving unit comprises:
a receiving section that receives the group of data transmitted by the transmitting section;
a re-replacement table generating section into which a replacement rule for replacing a corresponding counterpart in one-to-one correspondence between a plurality of data values and a plurality of codes with another counterpart included in the correspondence is inputted, and which replaces, according to the replacement rule, the corresponding counterpart in the correspondence described in the replacement table in the group of data received by the receiving section, with another counterpart, thereby generating a re-replacement table; and
a decoding section that decodes the encoded data in the group of data received by the receiving section to a data value by using the re-replacement table generated by the re-replacement table generating section.

Incidentally, regarding the transmitting apparatus, the receiving apparatus, the radiographic image transfer system, and the radiographic image diagnosis system according to the present invention, only a basic mode is explained here. However, this is for sake of avoiding redundancy, and in the receiving apparatus, the radiographic image transfer system, and the radiographic image diagnosis system according to the present invention, not only the basic mode but also various types of modes corresponding to the respective modes of the above-described data transfer system.

As described above, according to the present invention, it is possible to realize the data transfer system, the transmitting apparatus, the receiving apparatus, the radiographic image transfer system, and the radiographic image diagnosis system capable of avoiding slowdown of processing while protecting contents of data to be transferred.

### BRIEF DESCRIPTION OF THE DRAWINGS

FIG. 1 is a diagram of a radiographic image diagnosis system;

FIG. 2 is a block diagram illustrating a compression processing section in FIG. 1;

FIG. 3 is a block diagram illustrating a decompression processing section in FIG. 1;

FIG. 4 is a diagram illustrating a structure of image data supplied to a differential encoding section;

FIG. 5 is a diagram illustrating a structure of data after the data is subjected to two-dimensional differential encoding processing in the differential encoding section;

FIG. 6 is a diagram illustrating the two-dimensional differential encoding processing in the differential encoding section illustrated in FIG. 2, by way of example;

FIG. 7 is a diagram illustrating an example of histogram of image data;

FIG. 8 is a diagram illustrating an effect of the two-dimensional differential encoding and offset applied to the image data illustrated in FIG. 7;

FIG. 9 is a diagram explaining an effect of data division by a plane division section;

FIG. 10 is a diagram explaining encoding in the run-length encoding section in FIG. 2;

FIG. 11 is a diagram illustrating an algorithm of the encoding that targets to-be-compressed numeric values in the run-length encoding section;

FIG. 12 is a diagram illustrating an example of the encoding processing according to the number of consecutive pieces in the run-length encoding section in FIG. 2;

FIG. 13 is a diagram illustrating an example of the result obtained by scanning of the data scanning section;

FIG. 14 is a diagram illustrating an example of Huffman table;

FIG. 15 is a diagram illustrating specific examples of the code string prepared in the Huffman table;

FIG. 16 is a diagram illustrating the Huffman table in which correspondence between to-be-converted numeric values and codes in FIG. 15 is described;

FIG. 17 is a diagram illustrating the structure of a frame generated by a frame integration section and an example of the replacement table;

FIG. 18 is a diagram illustrating an example of replacement rules stored in the external storage medium in FIG. 1;

FIG. 19 is a diagram illustrating a display example of the image data that is decompressed in the decompression processing section;

FIG. 20 is a diagram illustrating a display example of the image data that is decompressed when a replacement rule is not obtained;

FIG. 21 is a diagram illustrating the structure of a frame generated by a frame integration section in a second embodiment of the invention and an example of the replacement table;

FIG. 22 is a diagram illustrating replacement rules stored in the external storage medium in the second embodiment;

FIG. 23 is a diagram illustrating a display example of the image data that is decompressed when a replacement rule is not obtained in the second embodiment;

FIG. 24 is a diagram illustrating a compression processing section in a third embodiment;

FIG. 25 is a diagram illustrating a concept of thinning processing performed by a thinning processing section in FIG. 24;

FIG. 26 is a diagram illustrating an encoding mode of encoding to a 4-bit code; and

FIG. 27 is a block diagram illustrating a medical image transfer system via a network.

### DETAILED DESCRIPTION OF THE INVENTION

An exemplary embodiment of the present invention will be described with reference to the accompanying diagrams.

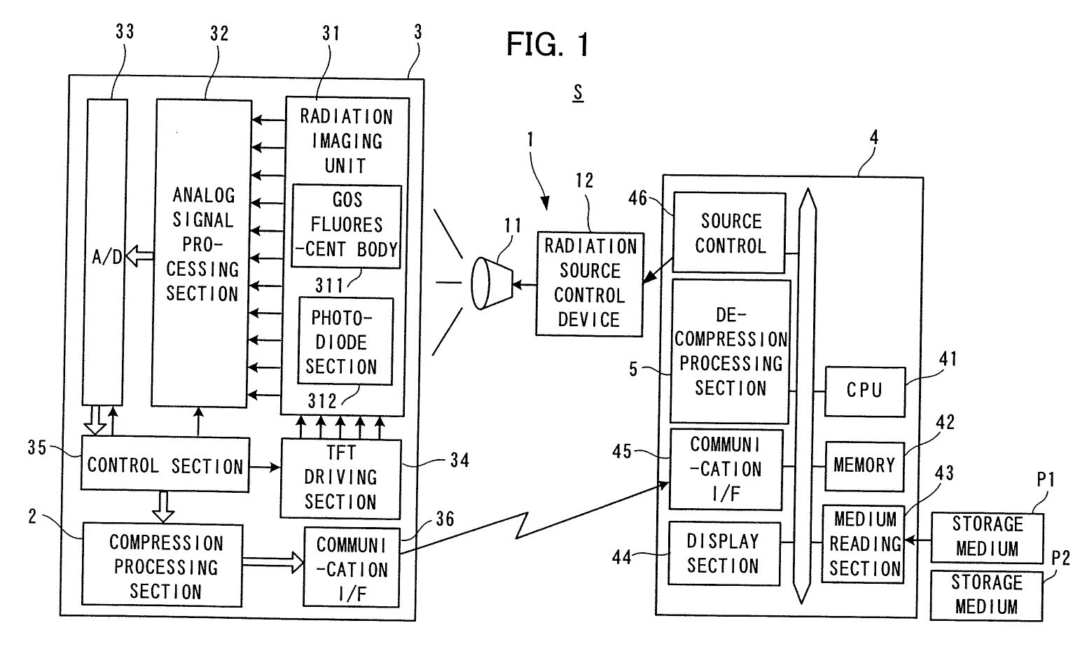

FIG. 1 is a diagram of a radiographic image diagnosis system.

A radiographic image diagnosis system S illustrated in FIG. 1 includes a radiation exposure apparatus 1, a radiation source control apparatus 12, a radiation detection unit 3, a system controller 4, and external storage media P1, P2.

The radiation exposure apparatus 1 includes a radiation source 11 to emit X-rays and a radiation source control apparatus 12. In the radiation source 11, the emission of X-rays is controlled by the radiation source control apparatus 12.

The radiation detection unit 3 detects a radiation image according to radiation emitted from the radiation source 11 and passing through a subject, further compresses image data representing the detected radiation image and transmits it wirelessly to the system controller 4.

The system controller 4 decompresses the transmitted compressed data, displays the decompressed image data on a display, and as needed, performs necessary processing for diagnosis to the image data.

The external storage media P1, P2 are, for example, portable memory cards, and possessed by a particular user such as a doctor who diagnoses by watching a radiographic image and an engineer who operates the radiographic image diagnosis system S. Although details will be described later, in the external storage media P1, P2, data that is used in a decompression processing section 5 of the system controller 4 is stored.

The radiographic image diagnosis system S is one embodiment of the radiographic image diagnosis system and the radiographic image transfer system according to the present invention. Furthermore, the radiation detection unit 3 is one embodiment of the transmitting apparatus according to the present invention and the system controller 4 is one embodiment of the receiving apparatus according to the present invention.

The system controller 4 includes a CPU 41, a memory 42, a medium reading section 43, a display section 44, a communication interface (hereafter, interface is abbreviated as I/F) 45, the decompression processing section 5 and a source control section 46, which are connected to each other by a bus.

The CPU 41 executes a program stored in the memory 42 and controls the entire system controller 4 and the radiation detection unit 3. The medium reading section 43 is connected to the external storage media P1, P2 read data stored in the external storage media P1, P2. The communication I/F 45 handles wireless communications with the radiation detection unit 3 as described above, and the system controller 4 takes in compressed image data via the communication I/F 45 and transmits an instruction to a control section 35 of the radiation detection unit 3 via the communication I/F 45.

The source control section 46 transmits an instruction about radiation by the radiation source 11 to the radiation source control apparatus 12 and the radiation source control apparatus 12 controls the radiation source 11 according to the received instruction.

The decompression processing section 5 restores the compressed image data transmitted from the radiation detection unit 3 and received via the communication I/F 45 to the image data before the compression. In the above-described memory 42, the received compressed image data and the restored image data are temporarily stored.

The radiation detection unit 3 includes a radiation imaging unit 31, an analog signal processing section 32, an analog/digital (hereafter, analog/digital is abbreviated as A/D) converter section 33, a thin-film transistor (hereafter, thin-film transistor is abbreviated as TFT) driving section 34, the control section 35, a communication I/F 36, and a compression processing section 2.

The radiation imaging unit 31 includes a GOS fluorescent body 311 made of a gadolinium oxide sulfate component (hereafter, gadolinium oxide sulfate is abbreviated as GOS) and a photodiode section 312 formed for each grid point on a TFT array. The GOS fluorescent body 311 converts the radiation emitted from the radiation source 11 and passing through the subject to visible light according to the magnitude of energy. In the photodiode section 312, the visible light is converted into an electric signal. The analog signal processing section 32 is configured using an operational amplifier for processing the electric signal and a capacitor. The TFT driving section 34 is a switching means and in switch-on, causes the GOS fluorescent body 311 to emit light according to the energy of received radiation and causes the photodiode section 312 to convert this light into an electric signal. The electric signal is taken into the analog signal processing section 32. After processing in the analog signal processing section 32, the signal is converted into digital data in the A/D converter section 33 to be outputted. Image data of the radiation image by the radiation received in the radiation imaging unit 31 is generated in this manner. The image data that is digital data is inputted into the compression processing section 2 via the control section 35.

The compression processing section 2 compresses a data amount of digital data by a means that will be described later in detail, and transmits it wirelessly every one line to a system controller side via the communication I/F 36. The control section 35 causes, following an instruction from the CPU 41 of the system controller 4, the TFT driving section 34, the analog signal processing section 32 and the A/D converter section 33 to be driven, and compression processing by the compression processing section 2 to be performed, transmission of the compressed data by the communication I/F 36 and the like to be performed.

Here, the communication I/F 36 of the radiation detection unit 3 corresponds to one example of the transmitting section according to the present invention, and the communication I/F 45 of the system controller 4 corresponds to one example of the receiving section according to the present invention.

Next, a flow of operations in the radiographic image diagnosis system S will be described. Incidentally, the following explanation is provided based on the assumption that at the time of performing X-ray shooting for a subject, a user who uses this radiographic image diagnosis system S waits for press down of switch for emitting X-ray from the radiation source 11, after the user already turns on power of each constituent apparatus, makes the subject stand at a predetermined stand position and waits for a display to appear on the display section of the system controller 4 indicating that X-ray shooting is available.

In the system controller 4, firstly the CPU 41 instructs the control section 35 of the radiation detection unit 3 to grasp a state of each section in the radiation detection unit 3, the control section 35 of the radiation detection unit 3 causes the compression processing section 2 to determine whether or not it is in a state possible to accept data, and write a code value representing the state in a register held in the compression processing section 2. The control section 35 reads the written code value and when determining that the read code value is of indicating a READY state and if each section except the compression processing section 2 has no problem, the control section 35 transmits a signal indicating that the radiation detection unit 3 is in the READY state to the CPU 41 of the system controller 4. In response to this, the system controller 4 causes a display section 44 to display that shooting is available. Then, the control section 35 of the radiation detection unit 3, after waiting for a notification of shooting execution from the system controller 4, controls each section of the radiation detection unit 3 to detect radiation emitted from the radiation source 11 and passing through the subject and convert the radiation image to digital data. Each time one line of digital data out of one frame of the digital data is inputted into the compression processing section 2, the control section 35 reports to the compression processing section 2. Each time the compression processing section 2 detects completion of data input of one line, performs compression processing to the data. The compressed data after being subjected to the compression processing in the compression processing section 2 is transmitted to the system controller 4 wirelessly via the communication I/F 36.

The compressed data that is transmitted is received by the communication I/F 45 of the system controller 4 and supplied to the decompression processing section 5. Further, when the user connects own external storage media P1, P2 to the medium reading section 43, the medium reading section 43 reads data stored in the external storage media P1, P2 and supplies to the decompression processing section 5. The compressed data supplied to the decompression processing section 5 is subjected to decompression processing using the data stored in the external storage media P1, P2. The image data after being subjected to the decompression processing is displayed on the display section 44. Furthermore, as needed, the image data is further subjected to image processing by the CPU 41.

Subsequently, internal configurations of the compression processing section 2 and the decompression processing section 5 will be explained.

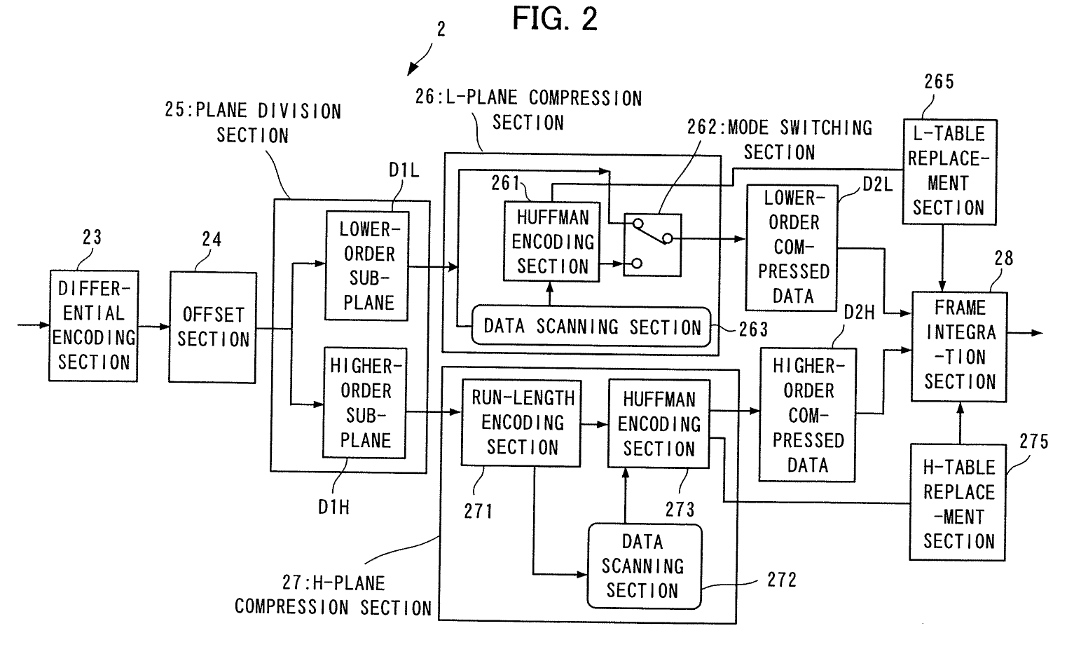

FIG. 2 is a block diagram illustrating the compression processing section illustrated in FIG. 1.

The compression processing section 2 in FIG. 2 includes a differential encoding section 23, an offset section 24, a plane division section 25, a L-plane compression section 26, a H-plane compression section 27, a L-table replacement section 265, a H-table replacement section 275, and a frame integration section 28.

To the differential encoding section 23, image data in a bitmap format in which each pixel is expressed by a 16-bit value is supplied from the control section 35 (FIG. 1). From the control section 35, the image data is transmitted per one line of the image, and the differential encoding section 23 temporarily stores data of a line that is received last time in a not-illustrated line buffer and performs encoding while referring to also this stored data. In the differential encoding section 23, a two-dimensional differential encoding processing, that is, a process in which, for the consecutive numeric values composing the inputted data, a two-dimensional difference is obtained based on plural numeric values which is adjacent to a numeric value in interest in plural directions respectively when viewed on the image is obtained, to generate image data made of consecutive 16-bit numeric values representing the differences is performed.

In the offset section 24, the image data made of consecutive numeric values representing the differences, which is generated in the differential encoding section 23 is offset by a predetermined offset value.

In the plane division section 25, each numeric value of the image data after the offset is divided into lower-order 8 bits and higher-order 8 bits, so that the image data is divided into a lower-order sub-plane D1L made of consecutive numeric values in lower-order bit and a higher-order sub-plane D1H made of consecutive numeric values in higher-order bit.

In the L-plane compression section 26 and the H-plane compression section 27, reversible compression is performed to each of the lower-order sub-plane D1L and the higher-order sub-plane D1H which are divided by the plane division section 25.

The frame integration section 28 combines a lower-order compressed data D2L and a higher-order compressed data D2H outputted from the L-plane compression section 26 and the H-plane compression section 27, respectively, to generate a frame serving as the unit of data transmission. The frame composes compressed data with respect to original image data. In either of the L-plane compression section 26 and the H-plane compression section 27, encoding is performed using a Huffman table, and the Huffman table used for this encoding is combined into the frame as a header by the frame integration section 28. However, the Huffman table used in either of the L-plane compression section 26 and the H-plane compression section 27 is not directly inserted into the frame, but a replacement table is inserted, which is generated by replacing a part in the L-table replacement section 265 and the H-table replacement section 275, respectively. Details of the replacement will be described later.

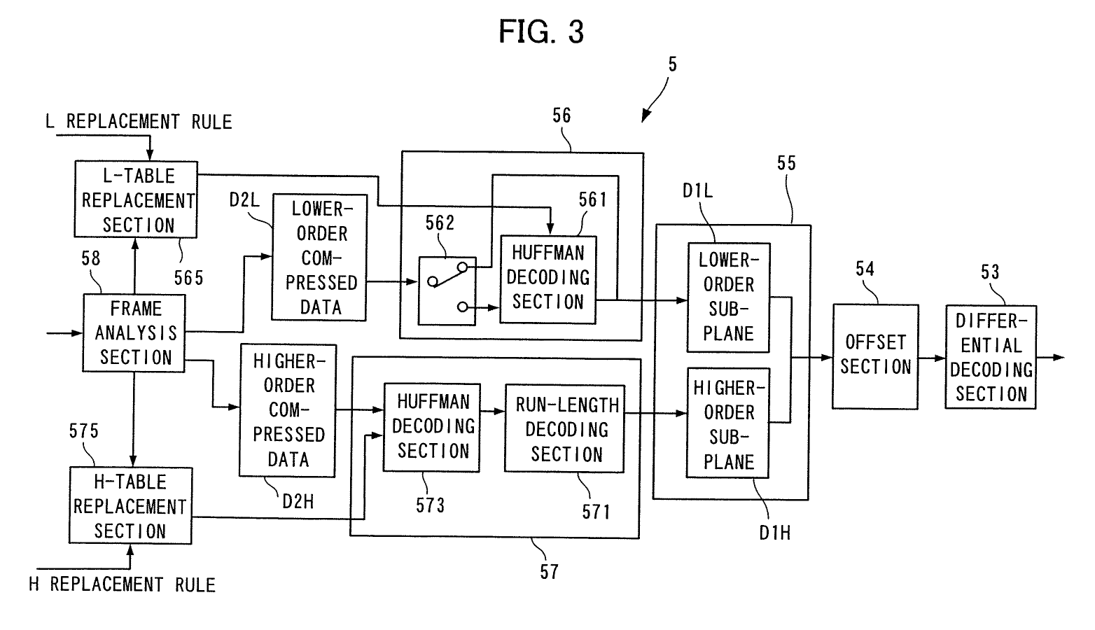

The frame generated in the frame integration section 28 is transferred to the decompression processing section of the system controller 4 via the communication I/F 36 illustrated in FIG. 1 and the communication I/F 45 of the system controller 4, and data decompression processing is performed to the compressed data. In performing the data decompression processing, decoding processing that corresponds to various types of encoding processing explained in FIG. 3 is performed to obtain image data.

FIG. 3 is a block diagram illustrating the decompression processing section illustrated in FIG. 1.

The decompression processing section 5 illustrated in FIG. 3 has a mirror-image structure of the compression processing section 2 and performs a reverse processing of the compression processing section 2 to generate image data. The decompression processing section 5 includes a frame analysis section 58, a L-table replacement section 565, a H-table replacement section 575, a L-plane decompression section 56, a H-plane decompression section 57, a plane integration section 55, an offset section 54 and a differential decoding section 53.

The frame analysis section 58 analyzes an inputted frame and extracts the lower-order compressed data D2L and the higher-order compressed data D2H from the frame. Also, from the header of the frame, the replacement table is extracted as well and supplied to the L-table replacement section 565 and the H-table replacement section 575, respectively. In the L-plane decompression section 56 and the H-plane decompression section 57, decompression processing is performed to the lower-order compressed data D2L and the higher-order compressed data D2H.

In the L-plane decompression section 56 and the H-plane decompression section 57, decoding is performed using a Huffman table, and the table used for this decoding is supplied from the L-table replacement section 565 and the H-table replacement section 575. The L-table replacement section 565 and the H-table replacement section 575 generate a re-replacement table by replacing corresponding counterparties in correspondence described in the replacement table with each other and supply the re-replacement table to the L-plane decompression section 56 and the H-plane decompression section 57 as the Huffman table used for decoding. When performing replacing with respect to the replacement table, the L-table replacement section 565 and the H-table replacement section 575 perform the replacing by a replacement rule read from the external storage media P1, P2. However, if any replacement rule is not read from the external storage media P1, P2 by the medium reading section 43, the L-table replacement section 565 and the H-table replacement section 575 do not perform the replacing and directly supply the replacement table as it is as the re-replacement table.

The plane integration section 55 defines the lower-order sub-plane D1L generated by the L-plane decompression section 56 as a numeric value in the lower-order bit and the higher-order sub-plane D1H generated by the H-plane decompression section 57 as a numeric value in the higher-order bit, and integrates the lower-order bit and the higher-order bit.

In the offset section 54, either of the numeric values integrated by the plane integration section 55 is offset by a predetermined offset value.

The differential decoding section 53 defines the consecutive numeric values that are offset by the offset section 54 as data representing a difference and performs to the data, a calculation that is the reverse of the differential encoding section 23 (FIG. 2). With this, the image data in the bitmap format before the compression, which is inputted into the differential encoding section 23 is restored. However, for completely restoring the image data before being subjected to the compression processing by the decompression processing section 5, it is necessary as a condition that a correct replacement rule is inputted into the L-table replacement section 565 and the H-table replacement section 575.

Here, each of the L-table replacement section 265 and the H-table replacement section 275 corresponds to one example of the replacement table generating section according to the invention. Further, each of the Huffman encoding sections 261, 273 corresponds to one example of the encoding section according to the invention, and each of the L-table replacement section 565 and the H-table replacement section 575 corresponds to one example of the re-replacement table generating section according to the invention. Furthermore, the Huffman decoding sections 561, 573 correspond to one example of the decoding section according to the invention, and the differential encoding section 23 corresponds to one example of the differential generating section according to the invention. Moreover, each of the L-plane compression section 26 and the H-plane compression section 27 corresponds to one example of the compression section according to the invention. The H-plane compression section 27 corresponds to one example of the higher-order data compression section according to the invention, and the L-plane compression section 26 corresponds to one example of the lower-order data compression section according to the invention. Still more, the run-length encoding section 271 corresponds to one example of the consecutive encoding section according to the invention, and data scanning sections 263, 272 correspond to one example of the histogram calculation section and the code assignment section according to the invention.

Here, again returning to FIG. 2 to explain a flow of compression of image data in the compression processing section 2.

As previously described, the image data that is transmitted from the control section 35 (FIG. 1) and in which each pixel is represented by a 16-bit value, is subjected to the two-dimensional differential encoding processing in the differential encoding section 23, offset by the offset section 24, and then divided into lower-order 8-bit and higher-order 8-bit in the plane division section 25, thereby the image data is divided into the lower-order sub-plane D1L made of consecutive numeric values in lower-order bit and the higher-order sub-plane D1H made of consecutive numeric values in higher-order bit.

The L-plane compression section 26 includes the Huffman encoding section 261, a mode switching section 262 to switch the mode to either of a high-speed mode or a normal mode, and the data scanning section 263. The lower-order sub-plane D1L inputted from the plane division section 25 is inputted into both of the data scanning section 263 and the Huffman encoding section 261 of the L-plane compression section 26.

In the data scanning section 263, all the data of the lower-order sub-plane D1L or a part of data that is thinned out is scanned and frequencies of occurrence (histogram) for all numeric values occurring in the data are determined. Here, in the present embodiment, processing of obtaining the frequencies of occurrence is performed with each lower-order sub-plane D1L illustrated in FIG. 2 as a unit, and frequencies of occurrence of numeric values in the data, of each lower-order sub-plane D1L are obtained.

In addition, the data scanning section 263 allocates, based on the obtained data histogram (frequency of occurrence of numeric value), a code with a shorter code length for numeric values with greater frequency of occurrence in the Huffman table. In this way, the Huffman table in which numeric values and codes are associated by the data scanning section 263 is updated.

The Huffman table in which codes are allocated to numeric values by the data scanning section 263 is passed to the Huffman encoding section 261. Subsequently, the Huffman encoding section 261 of the L-plane compression section 26 performs encoding processing to replace numeric values that make up of the lower-order sub-plane D1L inputted into the Huffman encoding section 261 with codes according to the passed Huffman table.

A mode switching section 262 in the L-plane compression section 26 is given an instruction from an user to switch between a high-speed mode and a normal mode, thereby switching between the normal mode through Huffman encoding by the Huffman encoding section 261 and the high-speed mode in which the lower-order sub-plane D1L is directly outputted while omitting the Huffman encoding. Accordingly, ultimately from the L-plane compression section 26, in a case of the normal mode, the lower-order compressed data D2L in which the lower-order sub-plane D1L is compressed by the Huffman encoding, and in a case of the high-speed mode, a lower-order compressed data D2L without being subjected to the Huffman encoding is outputted.

The H-plane compression section 27 includes the run-length encoding section 271, the data scanning section 272, and the Huffman encoding section 273. The higher-order sub-plane D1H inputted from the plane division section 25 is inputted into the run-length encoding section 271 in the H-plane compression section 27.

In the run-length encoding section 271 in the H-plane compression section 27, for the higher-order sub-plane D1H, encoding is performed in which, according to the number of consecutive pieces of an identical to-be-compressed numeric value, the number of consecutive pieces is expressed in a different bit. Here, specifically, when the number of consecutive pieces of the identical to-be-compressed numeric value is equal to or less than a predetermined number, the number of consecutive pieces is expressed in a bit number in 1 unit, whereas when the number of consecutive pieces is more than the predetermined number, the number of consecutive pieces is expressed in a bit in 2 unit. The data encoded in the run-length encoding section 271 is subsequently inputted into both of the data scanning section 272 and the Huffman encoding section 273.

In the data scanning section 272, all the data after encoded by the run-length encoding section 271 or a part of the data that is thinned out is scanned and frequencies of occurrence (histogram) for all numeric values occurring in the data are determined. Here, in the present embodiment, processing of obtaining the frequencies of occurrence is performed for each higher-order sub-plane D1H illustrated in FIG. 2 as a unit, and frequencies of occurrence of numeric values in the data after encoded by the run-length encoding section 271, of each higher-order sub-plane D1H are obtained.

In addition, the data scanning section 272 allocates, based on the obtained data histogram (frequency of occurrence of numerical value), a code with a shorter code length for numerical value with a greater frequency of occurrence. In this way, the Huffman table in which numeric values and codes are associated is updated by the data scanning section 272.

The Huffman table in which codes are allocated to numeric values by the data scanning section 272 is passed to the Huffman encoding section 273. The Huffman encoding section 273 performs encoding processing to replace numerical values of the data inputted into the Huffman encoding section 273 with codes according to the Huffman table, i.e., a code in which a numerical value with a greater frequency of occurrence is expressed in a shorter bit length.

The data after Huffman-encoded in the Huffman encoding section 273 is added with compression information including an allocation table of the numeric values and codes allocated by the data scanning section 272 and outputted from the H-plane compression section 27 as a higher-order compressed data D2H in which the higher-order sub-plane D1H is compressed.

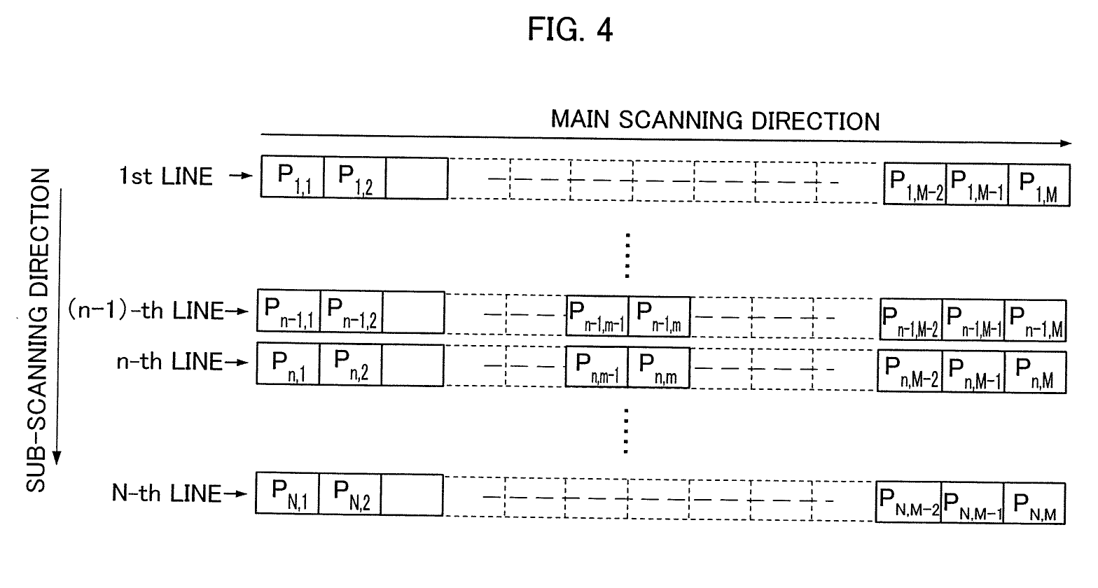

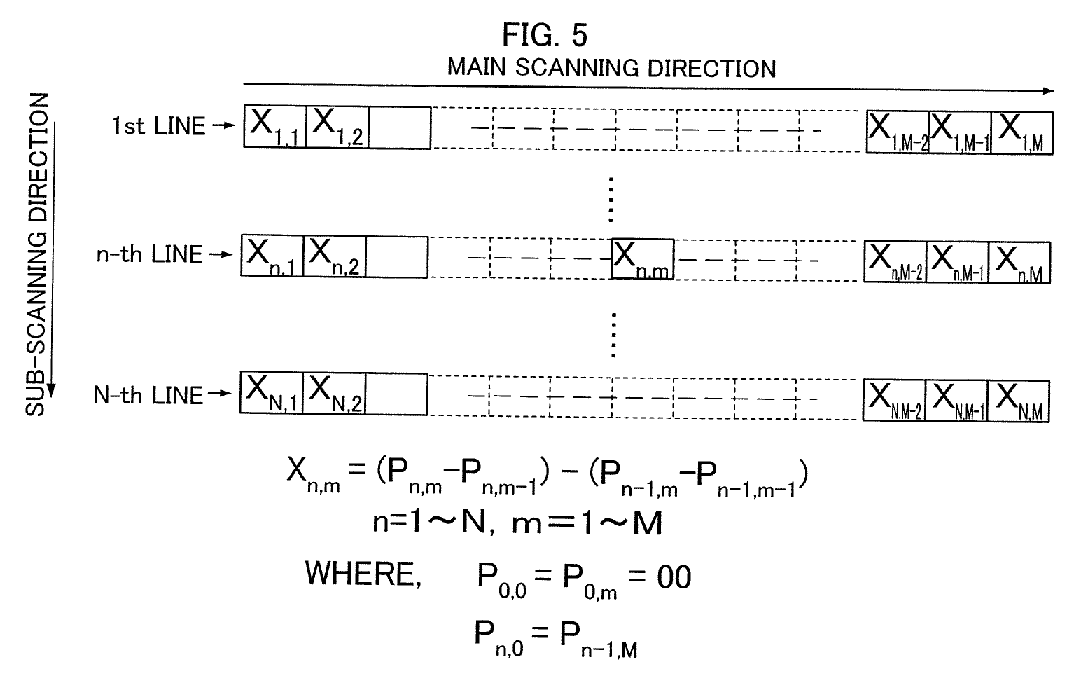

FIG. 4 is a diagram illustrating a structure of image data to be supplied to the differential encoding section, and FIG. 5 is a diagram illustrating a structure of the data after being subjected to the two-dimensional differential encoding processing in the differential encoding section.

An image represented by image data supplied from the control section 35 has such a structure that N lines, each of which is made up of M pixels aligned in a predetermined main scanning direction, are aligned in a sub scanning direction orthogonal to the main scanning direction. The image data reflects such a structure and thus also is configured such that N lines, each of which is made up of M pixel values aligned in the main scanning direction (a lateral direction in the diagram), are aligned in the sub scanning direction (a vertical direction in the diagram) as illustrated in FIG. 4. In this diagram, the m-th pixel value from left in the n-th line from the top is denoted by P_{n,m}. By using this notation, in the line at the n-th position in the sub-scanning direction, pixel values of the respective pixels aligned in the main scanning direction are denoted in the alignment order: P_{n,1}, P_{n,2}, . . . , P_{n,m-1}, P_{n,m}, . . . , P_{n,M-2}, P_{n,M-1}, P_{n,M}. These pixel values are numeric values expressed in hexadecimal notation.

Here, the image data described above is inputted into the differential encoding section 23 illustrated in FIG. 2, where the image data is subjected to the two-dimensional differential encoding processing, to obtain a further difference in the sub-scanning direction as to the differences between pixels adjacent to each other in the main scanning direction.

FIG. 5 illustrates the structure of the data after being subjected to the two-dimensional differential encoding processing. This data also has such a structure that N lines, each of which is made up of M pixel values after the two-dimensional differential encoding, are aligned in the main scanning direction. In FIG. 5, the m-th pixel value, from left in the n-th line from the top, after being subjected to the two-dimensional differential encoding, is denoted in X_{n,m}. This pixel value X_{n,m} after the two-dimensional differential encoding is obtained from four pixel values (P_{n-1,m-1}, P_{n-1,m}, P_{n,m-1}, P_{n,m}) before the two-dimensional differential encoding illustrated in a central part of FIG. 4, based on a conversion formula shown below.

X_{n,m}=(P_{n,m}−P_{n-1,m})−(P_{n-1,m}−P_{n-1,m-1}) (1)

Here, in a case of n=1 or m=1, 0 appears as the subscript of the pixel value before the two-dimensional differential encoding on the right side. The pixel value whose subscript is 0 is defined as follows.

P_{0,0}=P_{0,m}=0000(m=1 to M), P_{n,0}=P_{n-1,M}, (n=1 to N) (2)

Here, “0000” of the formula (2) indicates that the value is zero when the pixel value is expressed in hexadecimal notation. In the following, the meanings of the formula (1) and the formula (2) will be briefly described.

The formula (1) indicates that the pixel value X_{n,m} after the two-dimensional differential encoding is obtained by the further difference, in the sub-scanning direction, of the difference (i.e., a value in the parenthesis) between pixels adjacent to each other in the main scanning direction. When the correlation between the pixel value P_{n,m} before the two-dimensional differential encoding and its adjacent pixel value is strong (i.e., when these pixel values are similar to each other in terms of size), the pixel value X_{n,m} after the two-dimensional differential encoding is close to zero.

The formula (2) represents the definition of each pixel value when a virtual 0th line in the sub-scanning direction and a virtual pixel value at the 0th position from left in each line are newly provided. In this definition, as to the main scanning direction, the pixel value at the left edge (the 0th pixel value P_{n,0} from left) and the pixel value P_{n-1,M} at the right edge in a line before the line where the pixel value at the left edge is present are regarded as identical. Further, in this definition, as to the sub-scanning direction, the uppermost pixel value in the diagram (the pixel value in the 0th line), namely P_{0,0} and P_{0,m} are fixed to 0.

In the data after the two-dimensional differential encoding, as to the pixel value in the first line and the first pixel value in each line, a term where a subscript is “0” appears in the right side of the conversion formula (1). Therefore, the definition of the formula (2) is applied. To be more specific, the pixel value in the first line after the two-dimensional differential encoding is expressed as shown below based on the formula (1) and the formula (2).

$${X}_{1 , 1} = {P}_{1 , 1} , \\ {X}_{1 , 2} = {P}_{1 , 1} - {P}_{1 , 1} , \\ {X}_{1 , 3} = {P}_{1 , 3} - {P}_{1 , 2} , \\ ⋯$$

$${X}_{1 , M} = {P}_{1 , M} - {P}_{1 , M - 1}$$

On the other hand, in the data after the two-dimensional differential encoding, the first pixel value of each line is expressed as shown below based on the formula (2).

$${X}_{1 , 1} = {P}_{1 , 1} , \\ {X}_{2 , 1} = ( {P}_{2 , 1} - {P}_{1 , M} ) - {P}_{1 , 1} , \\ {X}_{3 , 1} = ( {P}_{3 , 1} - {P}_{2 , M} ) - ( {P}_{2 , 1} - {P}_{1 , M} ) , \\ ⋯$$

$${X}_{N , 1} = ( {P}_{N , 1} - {P}_{N - 1 , M} ) - ( {P}_{N - 1 , 1} - {P}_{N - 2 , M} )$$

In this way, as to the pixel value in the first line and the first pixel value in each line, the way of the conversion is slightly peculiar. However, to the pixel values other than these pixel values, the formula (1) is directly applied without the definition of the formula (2) being applied. For example, the pixel values except the pixel value at the left edge among the pixel values in the second line are each expressed as shown below.

$${X}_{2 , 2} = ( {P}_{2 , 2} - {P}_{2 , 1} ) - ( {P}_{1 , 2} - {P}_{1 , 1} ) , \\ {X}_{2 , 3} = ( {P}_{2 , 3} - {P}_{2 , 2} ) - ( {P}_{1 , 3} - {P}_{1 , 2} ) , \\ ⋯$$

$${X}_{2 , M} = ( {P}_{2 , M} - {P}_{2 , M - 1} ) - ( {P}_{1 , M} - {P}_{1 , M - 1} )$$

This two-dimensional differential encoding processing will be described using concrete numeric values.

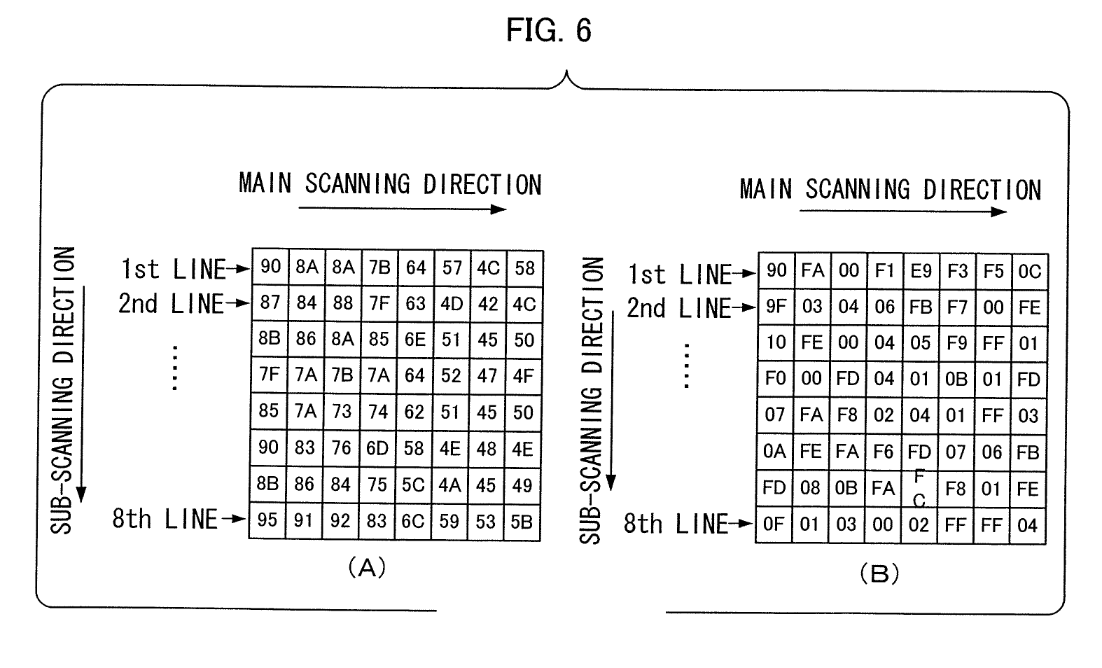

FIG. 6 is a diagram illustrating the two-dimensional differential encoding processing in the differential encoding section in FIG. 2, by way of example.

Each numeric value illustrated on the left side of FIG. 6 (part (A)) is a pixel value of image data, whereas each numeric value illustrated on the right side of FIG. 6 (part (B)) is an output value that is outputted by the two-dimensional differential encoding processing. The lateral direction in FIG. 6 is the main scanning direction, and a row formed by eight numeric values aligned along the main scanning direction is the above-described line. The data illustrated in FIG. 6 includes eight lines in total, each having such eight numeric values aligned therein. This data is equivalent to data in a case where N=8, M=8 in the data in FIG. 4 and FIG. 5. Incidentally, although the differential encoding section 23 in the present embodiment processes a value in 16 bits as data representing one pixel of image data, here, to avoid difficulty in recognizing the value, explanation will be made by the example of a value in 8 bits as data representing one pixel.

In the two-dimensional differential encoding processing applied to the data illustrated in part (A) of FIG. 6, at first, the leftmost “90” among pixel values “90 8A 8A 7B . . . ” in the first line is directly output as the above-mentioned X_{1,1} and as the remaining X_{1,2}, X_{1,3} and so on, differential values “8A−90=FA”, “8A−8A=00” and so on between pixel values adjacent to each other in the main scanning direction are output. Here, actually, the result of subtracting “90” from “8A” becomes a negative number and is represented by “1FA” in 9 bits. However, the higher-order “1” that is 1 bit of MSB is omitted, and only “FA” corresponding to lower-order 8 bits is outputted.

As to the second line, in the following formula to determine X_{2,1},

X_{2,1}=(P_{2,1}−P_{1,m})−P_{1,1}

where the numeric values illustrated in part (A) of FIG. 6 are substituted into (P_{2,1}, P_{1,8}, P_{1,1}) with defined as M=8 in the right side, and “(87−58)−90=9F” is outputted as X_{2,1}. As the remaining X_{2,2}, X_{2,3}, . . . , differences “(84−87)−(8A−90)=3”, “(88−84)−(8A−8A)=04”, . . . between the differences between the pixel values adjacent to each other in the main scanning direction in the second line and the differences between the pixel values adjacent to each other in the main scanning direction in the first line are outputted.

As to the third line, in the following formula to determine X_{3,1},

X_{3,1}=(P_{3,1}−P_{2,M})−(P_{2,1}−P_{1,M})

where the numeric values illustrated in part (A) of FIG. 6 are substituted into {P_{3,1}, P_{2,8}, P_{2,1}, P_{1,8}} with defined as M=8 in the right side, and “(8B−4C)−(87−58)=10” is outputted as X_{3,1}. As the remaining X_{3,2}, X_{3,3}, . . . , differences “(86−8B)−(84−87)=FE”, “(8A−86)−(88−84)=00”, . . . , between the differences between the pixel values adjacent to each other in the main scanning direction in the third line and the differences between the pixel values adjacent to each other in the main scanning direction in the second line are outputted.

As to the fourth line and thereafter as well, each numeric value illustrated in part (B) of FIG. 6 is obtained by repeating the operation same as that for the third line.

Incidentally, in the differential decoding section 53 in the decompression processing section 5 illustrated in FIG. 3, the data that has undergone the two-dimensional differential decoding in this way is subjected to the decoding processing. In this decoding processing, a formula to determine P_{n,m} from the data after being subjected to the two-dimensional differential decoding is used, and this formula is obtained as follows.

A result of performing addition in the pixel value X_{i,j} after the two-dimensional differential encoding, from i=1 to i=m and further from j=1 to j=m, is expressed as the following formula (3), by using the formula (1) and the formula (2).

$$\begin{matrix}{\sum }_{i = 1}^{n} {\sum }_{j = 1}^{m} {X}_{i , j} = {\sum }_{i = 1}^{n} \{ \begin{matrix}{\sum }_{j = 1}^{m} ( {p}_{i , j} - {p}_{i , j - 1} ) - \\ {\sum }_{j = 1}^{m} ( {p}_{i - 1 , j} - {p}_{i - 1 , j - 1} )\end{matrix} \} \\ = {\sum }_{i = 1}^{n} \{ ( {P}_{i , m} - {P}_{i , 0} ) - ( {P}_{i - 1 , m} - {P}_{i - 1 , 0} ) \} \\ = {\sum }_{i = 1}^{n} \{ ( {P}_{i , m} - {P}_{i - 1 , m} ) - ( {P}_{i , 0} - {P}_{i - 1 , 0} ) \} \\ = ( {P}_{n , m} - {P}_{0 , m} ) - ( {P}_{n , 0} - {P}_{0 , 0} ) \\ = {P}_{n , m} - {P}_{n - 1 , M}\end{matrix} \qquad ( 3 )$$

Here, to {P_{0,0}, P_{n,0}, P_{0,m}} appearing in the middle of the formula, the formula (2) is applied. Based on this formula, the pixel value P_{n,m} before the two-dimensional differential encoding is expressed as the following formula (4).

$${P}_{n , m} = {\sum }_{i = 1}^{n} {\sum }_{j = 1}^{m} {X}_{i , j} + {P}_{n - 1 , M} \qquad ( 4 )$$

In the differential decoding section 53 in the decompression processing section 5, at first, the pixel value P_{1,1}, P_{1,2}, . . . , P_{1,M} in the first line are determined by the formula (4). For example, by substituting n=1 into the formula (4) and further using P_{0,M}=0, the m-th pixel value in the main scanning direction among the pixel values in the first line is represented by the following formula (5).

$${P}_{1 , m} = {\sum }_{j = 1}^{m} {X}_{1 , j} \qquad ( 5 )$$

In this way, the pixel values P_{1,1}, P_{1,2}, . . . , P_{1,M} in the first line are all determined.

The pixel values P_{2,1}, P_{2,1}, . . . , P_{2,M} are obtained similarly by substituting n=2 into the formula (4) and using P_{1,M} obtained by the decoding of the pixel values in the first line. For example, the m-th pixel value in the main scanning direction among the pixel values in the second line is expressed by the following formula (6).

$${P}_{2 , m} = {\sum }_{j = 1}^{m} ( {X}_{1 , j} + {X}_{2 , j} ) + {P}_{1 , M} \qquad ( 6 )$$

The pixel values in the third line and thereafter also are similarly determined by using the pixel values decoded by the formula (6) and the computation thereafter. In the differential decoding section 53 of the decompression processing section 5 illustrated in FIG. 3, the decoding processing of data is performed in this way.

In the differential encoding section 23 in FIG. 2, image data is subjected to the two-dimensional differential encoding as described above. The data obtained by this two-dimensional differential encoding is inputted into the offset section 24 in FIG. 2, an offset value of “0x0080” is added to each numeric value of the data, and the data is divided into the lower-order sub-plane D1L and the higher-order sub-plane D1H. Here, processing up to the division of the data will be described in detail.

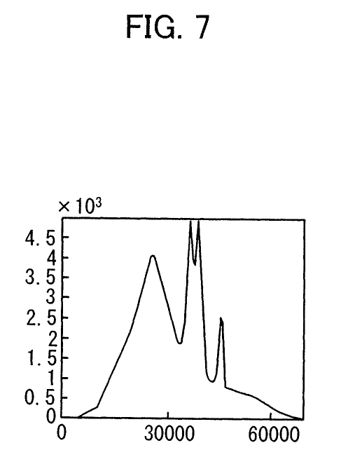

FIG. 7 is a diagram illustrating an example of histogram of image data supplied to the differential encoding section from the control section. In FIG. 7, a histogram of data values in the image data supplied from the control section 35 (FIG. 1) is illustrated, and the horizontal axis of this histogram denotes the data value, while the vertical axis denotes the number of pieces of data (the number of pixels).

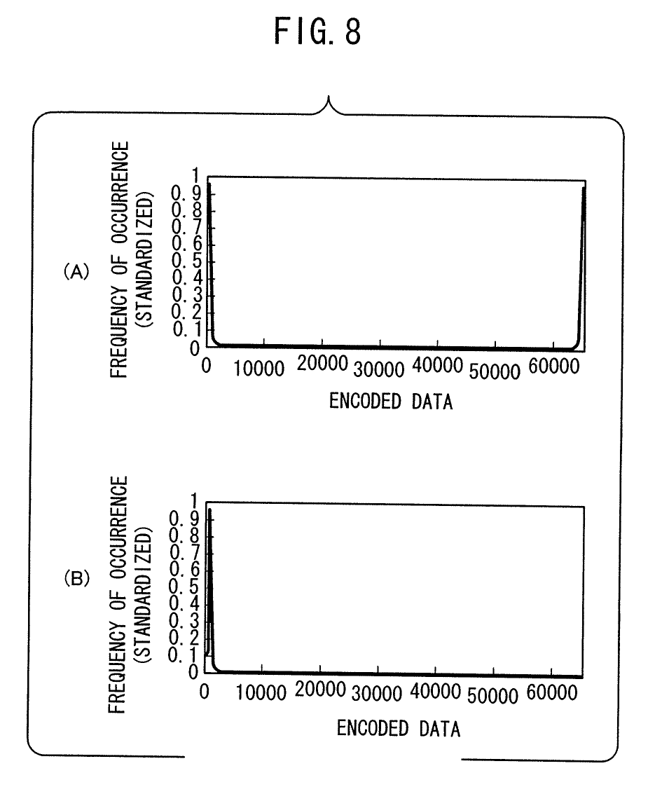

FIG. 8 is a diagram illustrating effects of the differential encoding and the offset for the image data illustrated in FIG. 7.

In part (A) of FIG. 8, there is illustrated a histogram of data obtained by subjecting the image data illustrated in FIG. 7 to the differential encoding. The horizontal axis of this histogram denotes the data value, while the vertical axis denotes the frequency of occurrence. This diagram illustrates a state when the image data is subjected to the differential encoding, the histogram of the data has a sharp peak at each of the minimum data value and the maximum data value. And, when such data is offset by an offset value of “0x008”, the histogram of the data has a sharp peak at the offset value of “0x0080” as illustrated in part (B) of FIG. 8. (In this case, the offset value of “0x0080” is 16-bit data and in a case in which the offset value is 8-bit data, the histogram of the data has a sharp peak at an offset value of “0x08”.) The data whose histogram is transformed by the differential encoding and the offset in this way is divided into the lower-order sub-plane D1L and the higher-order sub-plane D1H by the plane division section 25 illustrated in FIG. 2.

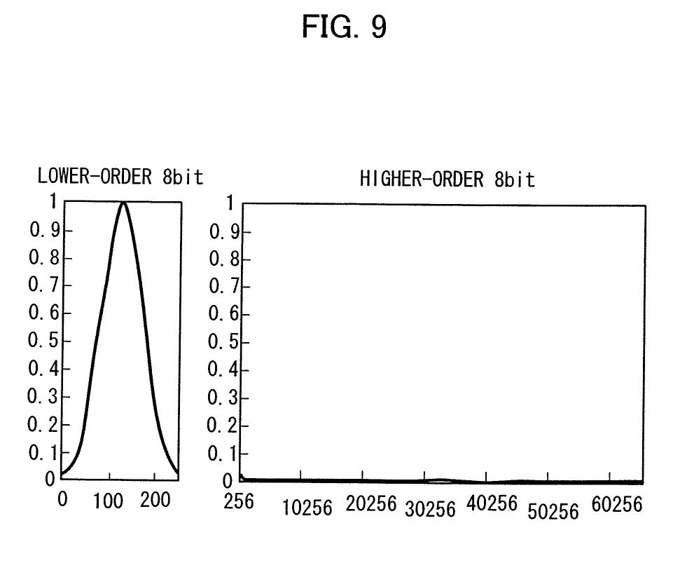

FIG. 9 is a diagram explaining an effect of the data division by the plane division section.

FIG. 9 illustrates a histogram obtained by dividing the histogram illustrated in part (B) of FIG. 8 between the data value “255” and the data value “256”. The data division by the plane division section 25 in FIG. 2 produces an effect equivalent to this division of the histogram. In other words, in the present embodiment, each of 16-bit numeric vales forming the data is divided into higher-order 8 bits and lower-order 8 bits, so that there are obtained the lower-order sub-plane D1L made up of consecutive numeric values represented by the lower-order 8 bits and the higher-order sub-plane D1H made up of consecutive numeric values represented by the higher-order 8 bits. Further, when it is interpreted that the 8-bit numeric values of the lower-order sub-plane D1L directly represent the numeric values from “0” to “255”, and the 8-bit numeric values of the higher-order sub-plane D1H represent numeric values from “256” to “65535”, the histogram of the lower-order sub-plane D1L is almost same as the histogram illustrated on the left side in FIG. 9, and the histogram of the higher-order sub-plane D1H is almost same as the histogram illustrated on the right side in FIG. 9. However, in the histogram of the higher-order sub-plane, a peak having a height equal to an area of the histogram illustrated on the left side in FIG. 9 is added at the data value “256” of the histogram illustrated on the right side.

In the following, processing of the data after being divided into the higher-order sub-plane D1H and the lower-order sub-plane D1L will be described.

First, the processing for the higher-order sub-plane D1H illustrated on the right side in FIG. 9 will be described.

As being apparent from that the frequencies of occurrence of the pixels in the histogram illustrated on the right side in FIG. 9 are almost zero, it is expected that most of the numeric values of the higher-order sub-plane D1H are consecutive values near zero (“00” and “01” and “FF” in hexadecimal notation). For this reason, in order to compress the higher-order sub-plane D1H, it is effective to perform run-length encoding in which compression is performed by encoding identical consecutive numeric values, and the higher-order sub-plane D1H is inputted into the run-length encoding section 271 that is one of the constituent elements of the H-plane compression section 27 illustrated in FIG. 2.

In the present embodiment, consecutive 8-bit numeric values of the higher-order sub-plane D1H are treated in the run-length encoding section 271, and consecutive numeric values from values “00” to “FF” in hexadecimal notation are subjected to the following encoding processing.

In this encoding processing, only a particular numeric value of plural 8-bit numeric values is encoded. Therefore, in this run-length encoding section 271, a numeric value targeted for the encoding processing (here, this numeric value is referred to as a “to-be-compressed numeric value”) and the number of consecutive pieces of the to-be-compressed numeric values is detected from the received data.

In the present embodiment, for instance, three numeric values of “01”, “FF” and “00” are used as the to-be-compressed numeric value.

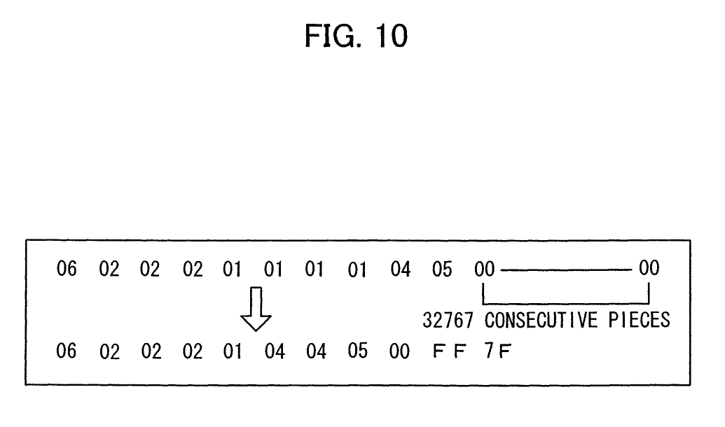

FIG. 10 is a diagram explaining the encoding in the run-length encoding section illustrated in FIG. 2.

The upper line in FIG. 10 represents data of the higher-order sub-plane D1H, and the lower line represents data after being subjected to the encoding processing in the run-length encoding section 271.

Here, as illustrated in the upper line in FIG. 10, the data made up of “06 02 02 02 01 01 01 01 04 05 00 . . . ” is assumed to be inputted from the run-length encoding section 271. At this time, in the run-length encoding section 271 in FIG. 2, there are detected: the head “06” as well as the following “02 02 02” as not being the to-be-compressed numeric values; the subsequent four consecutive pieces of “01” as being the to-be-compressed numeric values; and subsequently, after “04” and “05”, consecutive 32767 pieces of “00” as being the to-be-compressed numeric values.

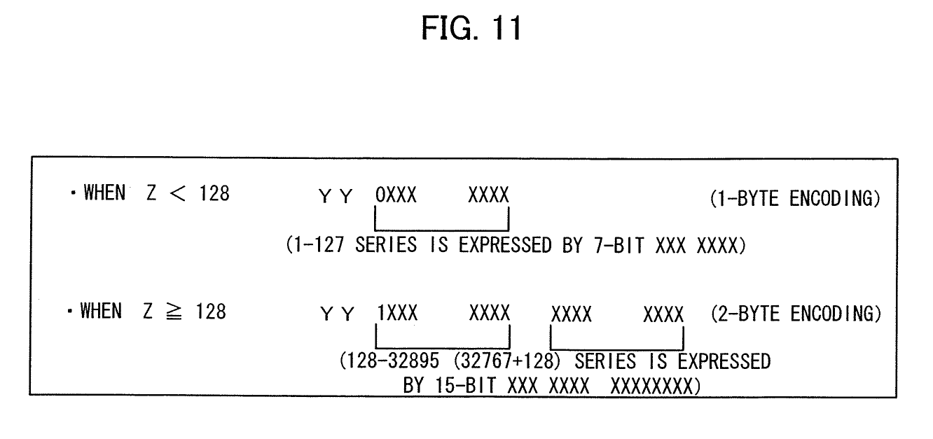

FIG. 11 is a diagram illustrating an algorithm of the encoding that targets the to-be-compressed numeric values in the run-length encoding section.

In FIG. 11, “Z” represents the number of consecutive pieces of an identical to-be-compressed numeric value. For example, in the upper line in FIG. 10, Z=4 for “01”, and Z=32767 for “00”.

Further, in FIG. 11, “YY” represents the to-be-compressed numeric value in two-digit hexadecimal notation. Following “YY,” “0” or “1” is “0” or “1” expressed in 1 bit, and in “XXX XXXX . . . ” subsequent thereto, a single “X” represents 1 bit, and the value of Z is expressed by this “XXX XXXX . . . ”.

In other words, FIG. 11 means that when the to-be-compressed numeric value “YY” continues for Z<128 pieces, the first byte expresses the to-be-compressed numeric value “YY”, the first bit of the next one byte is “0”, and the subsequent 7 bits express the value of “Z”. Further, FIG. 10 means that when the to-be-compressed numeric value “YY” continues for Z≧128 pieces, the first byte expresses the to-be-compressed numeric value “YY”, the expression covers the next 2 bytes (16 bits) by placing “1” at the first bit, and the subsequent 15 bits express the value of “Z”.

An example of the encoding illustrated in FIG. 10 will be described according to the rule illustrated in FIG. 11.

The head numeric value “06” of the data (upper line) of the higher-order sub-plane D1H inputted from the plane division section 25 in FIG. 2 is not the to-be-compressed numeric value and therefore, this “06” is directly outputted. Also, “02” of “02 02 02” subsequent to the head “06” is not the to-be-compressed numeric value and thus, these three of “02” also are directly outputted. Subsequently, there are four consecutive pieces of the to-be-compressed numeric value “01” and therefore, these are encoded into “01 04”. The next “04” and “05” are not the to-be-compressed numeric values and thus, “04 05” is directly outputted.

Subsequently, there are 32767 consecutive pieces of “00” and thus, “00” is placed, 1 bit at the head of the next 1 byte is turned “1”, and the next 15 bits are used to express 32767+128, so that there is expressed the fact that there are 32767 consecutive pieces of “00” by using 3 bytes of “00 FF 7F”. In other words, the number of consecutive pieces 128 is expressed by “00 00” except the first bit “1”.

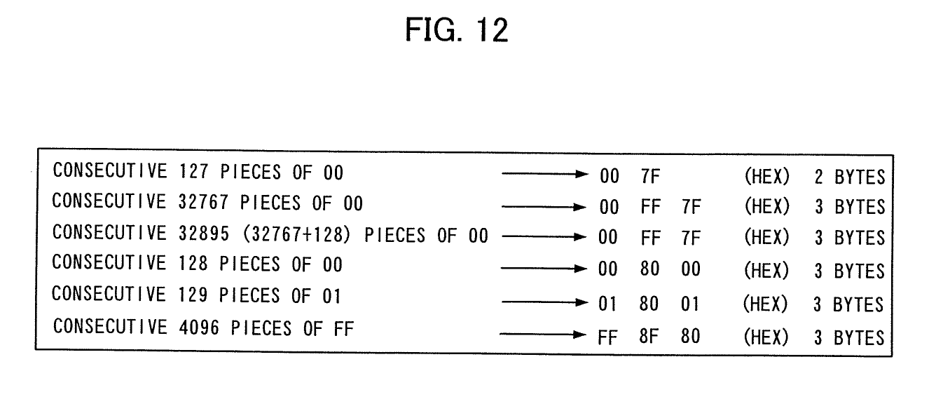

FIG. 12 is a diagram illustrating an example of the encoding processing according to the number of consecutive pieces in the run-length encoding section in FIG. 2.
When there are 127 consecutive pieces of “00”, these are encoded into “00 7F” using 2 bytes.
When there are 32767 consecutive pieces of “00”, these are encoded into “00 FF 7F” using 3 bytes.
When there are 32895 consecutive pieces of “00”, these are encoded into “00 FF FF” using 3 bytes.
When there are 128 consecutive pieces of “00”, these are encoded into “00 80 00” using 3 bytes.
When there are 129 consecutive pieces of “01”, these are encoded into “01 80 01” using 3 bytes.
When there are 4096 consecutive pieces of “FF”, these are encoded into “FF 8F 80” using 3 bytes.

In the run-length encoding section 271 illustrated in FIG. 2, the above-described encoding processing is performed.

According to the run-length encoding section 271 of the present embodiment, the maximum compression ratio improves up to 3/32895= 1/10965. Also, as described with reference to the histogram in FIG. 9, in the data of the higher-order sub-plane D1H targeted for the encoding processing by this run-length encoding section 271, most of 8-bit numeric values become numeric value “0” that corresponds to less than the original data value “256”. For this reason, significant data compression can be expected by the encoding processing in the run-length encoding section 271.

The data after being subjected to the encoding processing by the run-length encoding section 271 in FIG. 2 is subsequently inputted into the data scanning section 272 of the H-plane compression section 27 and the Huffman encoding section 273 in FIG. 2.

In this data scanning section 272, firstly, the whole data outputted from the run-length encoding section 271 is scanned, and the frequencies of occurrence of the data values are determined.

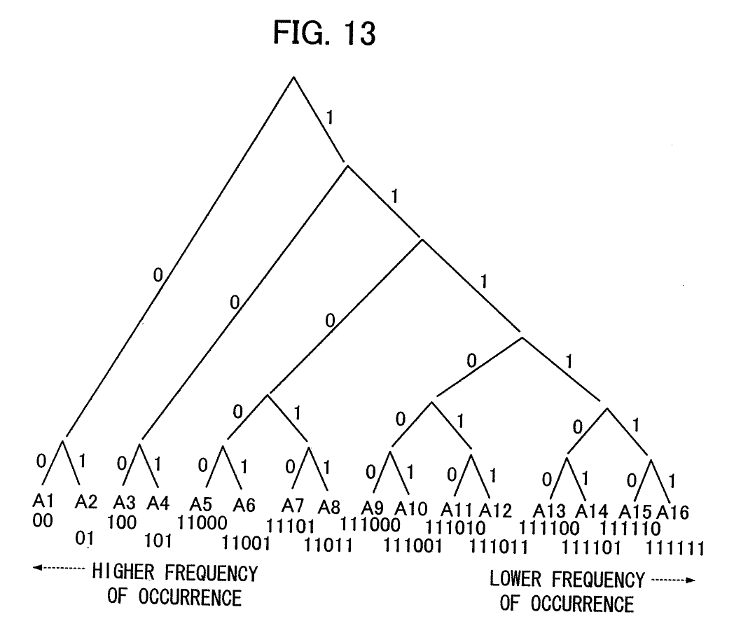

FIG. 13 is a diagram illustrating an example of the result obtained by scanning of the data scanning section.

Here, the frequency of occurrence of “A1” is the highest, followed by “A2”, “A3”, “A4”, and so on. Incidentally, these “A1”, “A2” and the like do not directly represent numeric values and are codes to express the numeric values. In other words, for example, “A1” expresses a numeric value “00”, and “A2” expresses a numeric value “FF”. Also, here, for the sake of simplicity, all the data values of the data sent from the run-length encoding section 271 in FIG. 2 are assumed to be any of 16 numeric values from “A1” to “A16”. Further, in the data scanning section 272, a code according to the frequency of occurrence is assigned to each of these 16 numeric values, and a Huffman table is created. In other words, a code “00” expressed in 2-bit is assigned to “A1” of the highest frequency of occurrence, and a code “01” expressed also in 2-bit is assigned to the next “A2”. Further, a code “100” and a code “101” each expressed in 3-bit are assigned to the next “A3” and further next “A4”, respectively, and each code expressed in 5-bit is assigned to each of the next “A5” to “A8”. Thereafter, similarly, a code expressed in the larger number of bit is assigned to the numeric value whose frequency of occurrence is lower.

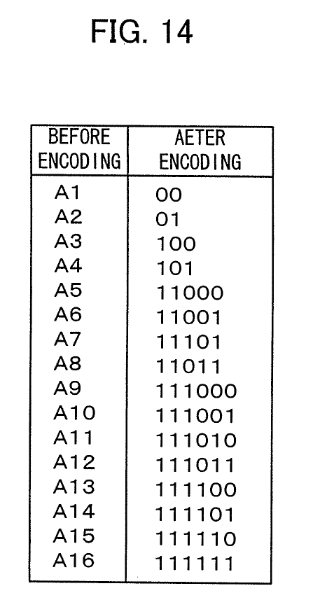

FIG. 14 is a diagram illustrating one example of the Huffman table.

This Huffman table is made to agree with FIG. 13. This is a correspondence table in which the numeric values are aligned so that the numeric values with higher frequencies of occurrence are replaced with the codes expressed in the smaller number of bits, and which shows correspondence between the numeric values before the encoding (before being replaced) and the numeric values after the encoding (after being replaced).

In the Huffman encoding section 273 of the H-plane compression section 27 in FIG. 2, the numeric values of data are encoded in accordance with the above-described Huffman table, and as a result, most of the numeric values are replaced with the codes in small numbers of bit, thereby realizing data compression.

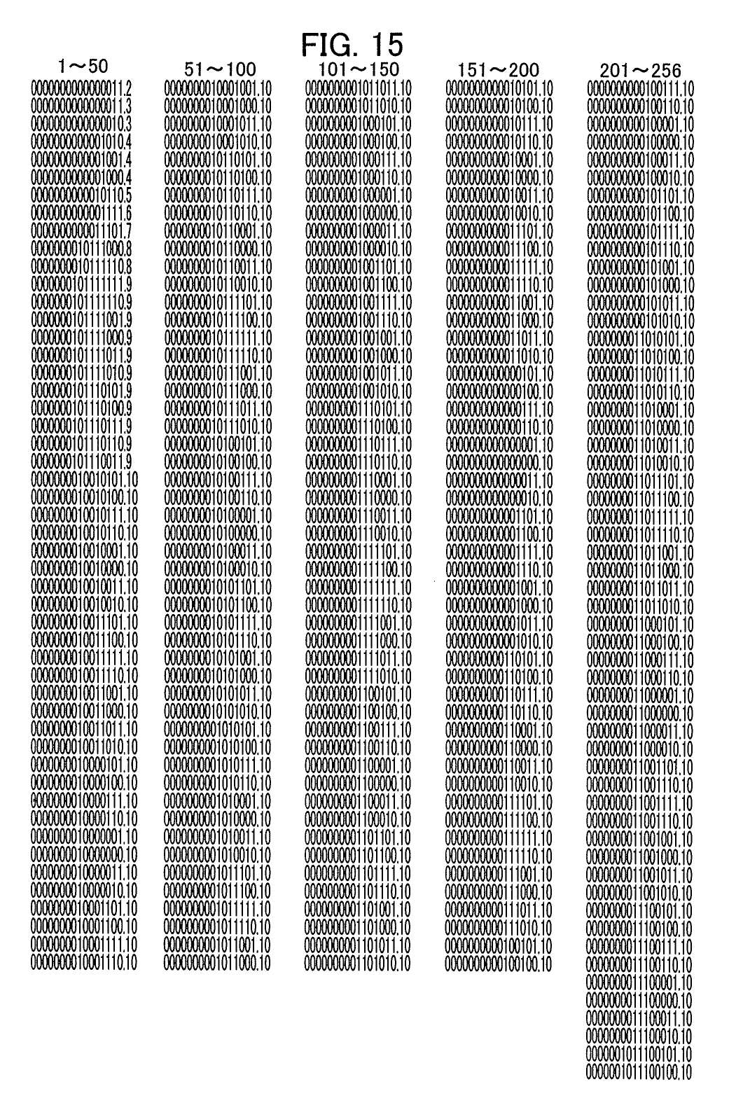

FIG. 15 is a diagram illustrating specific examples of the code string prepared in the Huffman table.

In each of the code strings illustrated in FIG. 15, a numeric value on the right side of “,” represents a bit length, and a binary code in the bit length aligned on the left side of the “,” represents an actual code. For example, the first code at the upper left in FIG. 15 is “11” in 2 bits, subsequently the second code is “011” in 3 bits, the third code is “010” in 3 bits, and the fourth code is “1010” in 4 bits. By using such a code string, the numeric values having higher frequencies of occurrence are replaced by the codes expressed in the smaller number of bits.

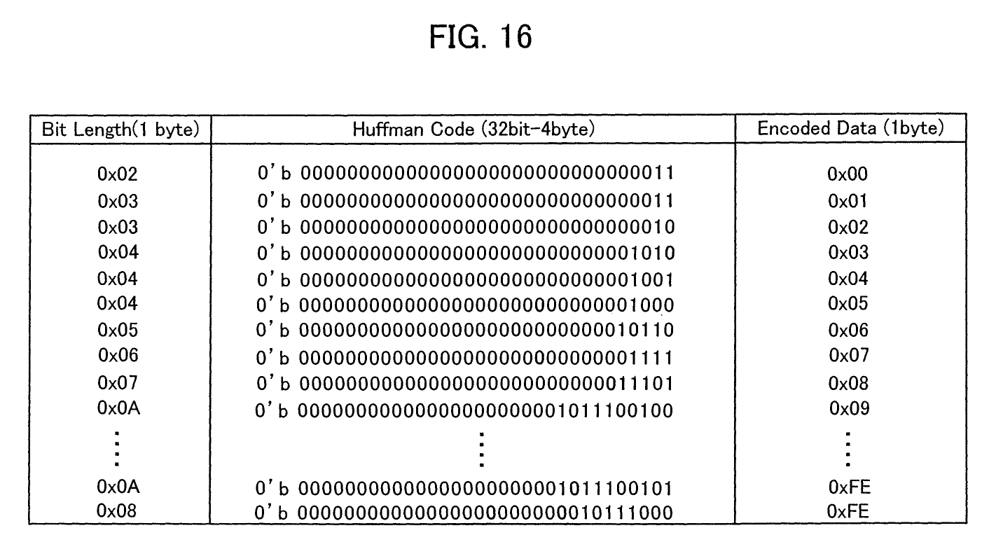

FIG. 16 is a diagram illustrating a Huffman table in which correspondence between to-be-converted numeric values and codes shown in FIG. 15 is described.

In the Huffman table in FIG. 16, a Huffman code is right-aligned and its left (higher-order side bits) is filled in with “0” to be expressed in binary notation of 32 bits. The Huffman code has a bit length expressed in hexadecimal notation in bit length. The Huffman table is generated by assigning a code according to a frequency of occurrence by the data scanning section 272, to a numeric value outputted from the run-length encoding section 271 (encoded data). In the example of Huffman table illustrated in FIG. 16, the first code “0′b11” is assigned to the numeric value “0x00”, and the second code “0′b011” is assigned to the numeric value “0x01”. In this way, all the 8-bit values are associated with Huffman codes.

The data encoded by the run-length encoding section 271 is converted into a code every 8 bits by the Huffman encoding section 273. By this conversion, the higher-order compressed data D2H that is variably encoded is generated.

By the above-described processing with reference to FIG. 10 through FIG. 15, the higher-order sub-plane D1H inputted into the H-plane compression section 27 in FIG. 2 is subjected to the encoding by the run-length encoding section 271 and the encoding by the Huffman encoding section 273, thereby being compressed using a high compression ratio and resulting in the higher-order compressed data D2H.

Next, the processing for the lower-order sub-plane D1L will be described. The lower-order sub-plane D1L obtained as a result of the division by the plane division section 25 is treated as consecutive 8-bit numeric values and subjected to the Huffman encoding processing described with reference to FIG. 13 through FIG. 15 in the Huffman encoding section 261. In the Huffman table used for conversion into a code in the Huffman encoding section 261, correspondence between a data value and a code is fixed indifferently from a frequency of occurrence of a value. The Huffman table of the lower-order sub-plane in the present embodiment has the same format as that of the example illustrated in FIG. 16, among the Huffman tables of the higher-order sub-plane. The data inputted to the L-plane compression section is converted into a code every 8 bits by the Huffman encoding section 261. By this conversion, the lower-order compressed data D2L that is variably encoded is generated.

Incidentally, as described above, when the high-speed mode is instructed by the user, the mode switching section 262 is switched and the lower-order sub-plane D1L is outputted from the L-plane compression section 26 as the lower-order compressed data D2L while the Huffman encoding processing by the Huffman encoding section 261 is omitted.

The higher-order compressed data D2H and the lower-order compressed data D2L are combined to generate one frame by the frame integration section 28, and the frame is transmitted via the communication I/F 36. In the frame, various types of settings necessary for the decompression processing of the frame are inserted as a header. Although a table used for the Huffman decoding is also included in this header, not the Huffman table that is used in the above-described Huffman encoding section 261, 273, but a replacement table in which a part of the Huffman table is replaced is included in the header.

In the Huffman table used in the Huffman encoding section 261 of the lower-order sub-plane, a corresponding counterpart in the correspondence described in the table is replaced with another counterpart included in the correspondence by the L-table replacement section 265, thereby a replacement table is generated. Also, in the Huffman table used in the Huffman encoding section 273 of the higher-order sub-plane, a corresponding counterpart in the correspondence described in the table is replaced with another counterpart included in the correspondence by the H-table replacement section 275.

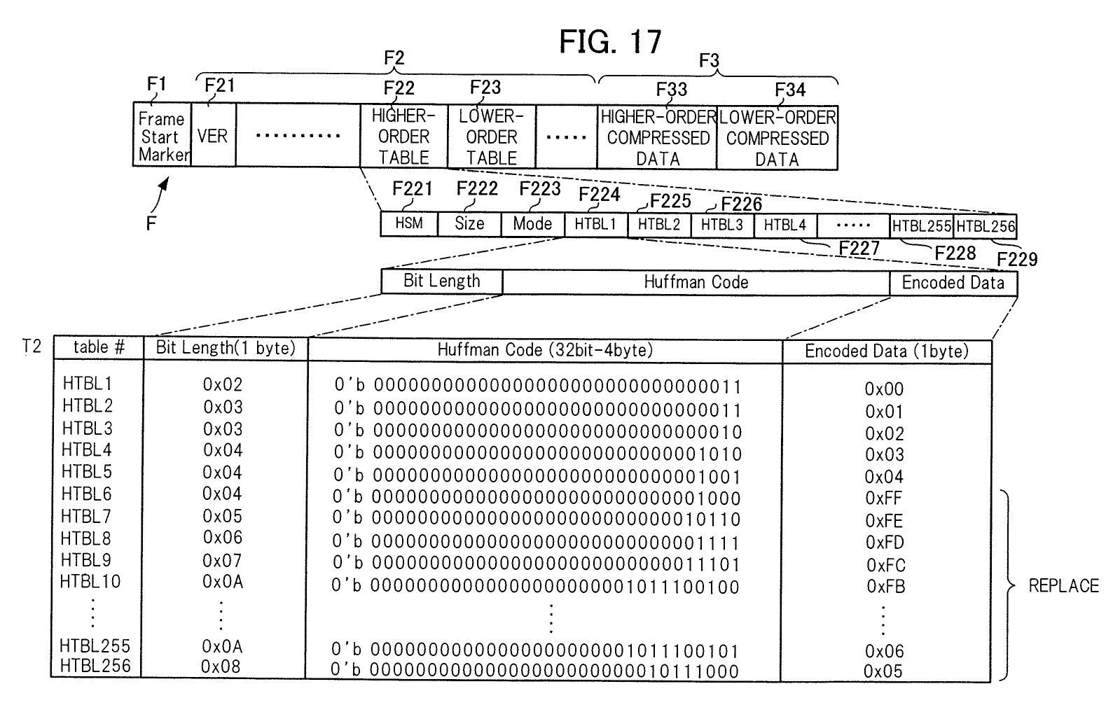

FIG. 17 is a diagram illustrating a structure of a frame generated by the frame integration section and an example of the replacement table.

Firstly, the structure of the frame will be explained.

A frame F illustrated in FIG. 7 includes, in an order of being outputted from the frame integration section 28, a frame start marker F1 representing a head of the frame, a header F2, and a payload f3. The header F2 includes a version F21 representing a number of the frame, a higher-order table F22, and a lower-order table F23. Further, the payload F3 includes a higher-order compressed data F33 and a lower-order compressed data F34. The higher-order compressed data F33 is the higher-order compressed data D2H generated in the Huffman encoding section 273 of the H-plane, and the lower-order compression data F34 is the lower-order compressed data D2L generated in the Huffman encoding section 261 of the L-plane.

Since the higher-order table F22 and the low-order table F23 included in the header F2 have an identical structure to each other, the higher-order table F22 will be described as a representative of them. The higher-order table F22 includes a Huffman start marker (HSM) F221 representing a start of the table, size information F222 representing a data length of the whole table, and mode information F223 representing a processing mode. Following the mode information F223 in the higher-order table F22, 256 pieces of data from the first Huffman table data (HTBL1) F224 representing correspondence of the first data in the table to the 256th Huffman table data (HTBL256) F229 representing correspondence of the 256th data are sequentially aligned. Each of the 256 pieces of Huffman table data F224, F225, F226, F227, . . . , F228, F229 represents one correspondence in the higher-order table, namely, contents of one line in the table made of 256 lines. Each of the 256 pieces of Huffman table data F224 through F229 includes a bit length (Bit Length) of the Huffman code, a 32-bit length Huffman code that is right-aligned and filled in with “0” and a numeric value associated with a Huffman code (encoded data). The higher-order table is represented by these 256 pieces of the Huffman table data F224 through F229.

A table T2 illustrated in FIG. 17 is a replacement table in which replacement processing is performed by the H-table replacement section 275 illustrated in FIG. 2. The H-table replacement section 275 generates the replacement table T2 illustrated in FIG. 17 by replacing a numeric value that is a corresponding counterpart of a code with a numeric value of another counterpart, in the correspondence from the 6th to the 256th in the Huffman table used in the Huffman encoding section 273. To be more specific, the alignment of the 251 pieces of numeric values in the correspondence from the 6th to the 256th in the Huffman table is replaced in a reverse order. For example, the 6th numeric value at the head is replaced with the 256th numeric value at the end of the list, and the 7th numeric value next to the head is replaced with the 255th numeric value immediately before the bottom of the list. The H-table replacement section 275 in the present embodiment does not perform the replacement for a portion from the 1st to the 5th where frequencies of occurrence referred to in the conversion are relatively high in the Huffman table and performs the replacement about a portion from the 6th to the 256th where frequencies of occurrence referred to in the conversion are relatively low.

The L-table replacement section 265 also generates a replacement table similarly as in the H-table replacement section 275, by replacing a numeric value that is a corresponding counterpart of a code with a numeric value of another counterpart, in the correspondence from the 6th to the 256th in the Huffman table used in the Huffman encoding section 261.

The two replacement tables generated by the H-table replacement section 275 and the L-table replacement section 265 are inserted into the header F2 of the frame F by the frame integration section 28. The frame integrated by the frame integration section 28 is transmitted wirelessly from the communication I/F 36 illustrated in FIG. 1 to the communication I/F 45 of the system controller 4 and subjected to the decompression processing in the decompression processing section 5.

In the decompression processing section 5 illustrated in FIG. 3, a decompression processing that is a reversal of the compression processing section 2 explained with reference to FIG. 2 and FIG. 3 through FIG. 16 is performed to generate image data. However, for complete restoration of the image data before being subjected to the compression processing, it is necessary to connect the external storage media P1, P2 to read out a correct replacement rule.

Firstly, the decompression processing in a case where the external storage media P1, P2 are connected and a correct replacement rule is obtained will be described.

The frame (see FIG. 17) inputted into the decompression processing section 5 illustrated in FIG. 3 is analyzed by the frame analysis section 58 to examine its frame structure, and the lower-order compressed data D2L, the higher-order compressed data D2H, and two replacement tables corresponding to these compressed data are taken out from the frame. The lower-order compressed data D2L and the higher-order compressed data D2H are supplied to the L-plane decompression section 56 and the H-plane decompression section 57, respectively. The replacement tables are supplied to the L-table replacement section 565 and the H-table replacement section 575, respectively. In the L-plane decompression section 56 and the H-plane decompression section 57, decoding is performed using the Huffman table, and the table used for this decoding is supplied from the L-table replacement section 565 and the H-table replacement section 575.

When an operator such as a medical doctor connects own external storage media P1, P2 (FIG. 1) to the system controller 4, the replacement rule stored in the external storage media P1, P2 is read out by the medium reading section 43 and supplied to the decompression processing section 5.

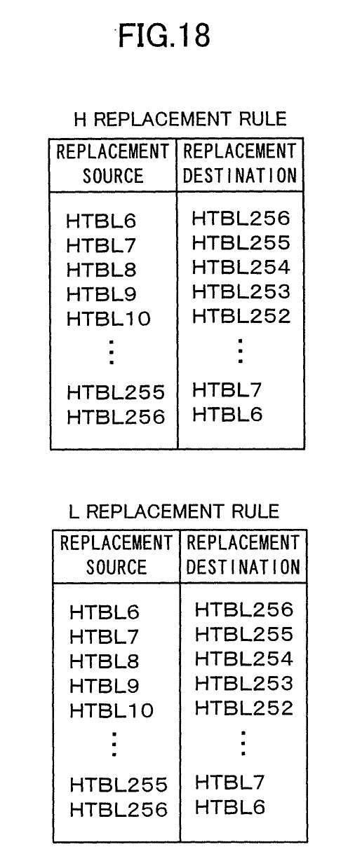

FIG. 18 is a diagram illustrating a replacement rule stored in the external storage medium illustrated in FIG. 1.

The contents stored in the two external storage media P1, P2 are identical and in either of them, both of the H-replacement rule and the L-replacement rule illustrated in FIG. 18 are stored.

The H-replacement rule stored in the external storage media P1, P2 is for restoring the table used for the encoding from the replacement table which is generated in the H-table replacement section 275 (see FIG. 2) by replacing the table used for encoding.

In the example illustrated in FIG. 18, since the contents of the H-replacement rule and the L-replacement rule are identical, the H-replacement rule will be explained as a representative of them.

The H-replacement rule illustrated in FIG. 18 illustrates a pair of replacement source and replacement destination. This rule indicates that, of the replacement table, a value corresponding with rank in the replacement source is put into a value corresponding with rank in the replacement destination. For example, the first in the H-replacement rule illustrated in FIG. 18 means that the 6th corresponding value is put into the 256th corresponding value in the replacement table. Also, the second in the H-replacement rule means that the 7th corresponding value is put into the 255th corresponding value in the replacement table.

This is also the same for the L-replacement rule illustrated in FIG. 18.

The replacement rules read from the external storage media P1, P2 by the medium reading section 43 are supplied to the L-table replacement section 565 and the H-table replacement section 575 of the decompression processing section 5. The L-table replacement section 565 and the H-table replacement section 575 replace a corresponding counterpart with another counterpart in the correspondence described in the replacement table according to the replacement rule, thereby generating a re-replacement table. For example, although in the H-replacement table supplied to the H-table replacement section 575 from the frame analysis section 58 illustrated in FIG. 3, corresponding parties in the correspondence from the 6th to the 256th are replaced as illustrated in FIG. 17, a re-replacement table that is identical to the table used for the encoding illustrated in FIG. 16 is restored by the re-replacement according to the H-replacement rule illustrated in FIG. 18. This is also the same for the L-table replacement section 565. Since the table used for the encoding and the re-replacement table are the same, hereafter the table illustrated in FIG. 16 is also referred to as the re-replacement table.

From the H-table replacement section 575, a re-replacement table that is identical to the table used for the encoding is supplied to the Huffman decoding section 573 of the H-plane decompression section 57, and the lower-order compressed data D2L supplied to the Huffman decoding section 573 is decoded to numeric values in the table by using the re-replacement table illustrated in FIG. 16. Here, a code representing the number of consecutive pieces of an identical target numeric value is replaced by the consecutive number so that the decoded numeric values become the higher-order sub-plane D1H.

From the L-table replacement section 565, the re-replacement table that is identical to the table used for the encoding is supplied to the Huffman decoding section 561 of the L-plane decompression section 56, and the lower-order compressed data D2L supplied to the Huffman decoding section 561 is decoded to numeric values in the table by using the re-replacement table illustrated in FIG. 16, to be the lower-order sub-plane D1L. The higher-order sub-plane D1H and the lower-order sub-plane D1L are integrated by the plane integration section 55 as the lower-order bit and the higher-order bit. Each of the integrated numeric values is offset by a predetermined offset value by the offset section 54 and by the differential decoding section 53, subjected to a calculation that is reversal of the differential encoding section 23 (FIG. 2). With this, the image data before the compression, which is inputted into the differential encoding section 23, is restored.

The restored image data is displayed on the display section 44 (see FIG. 1). In addition, the image data is displayed on the display section 44 after being subjected to processing of brightness enhancement and coloring to a portion having a particular image pattern by image processing of the CPU 41 to support diagnosis.

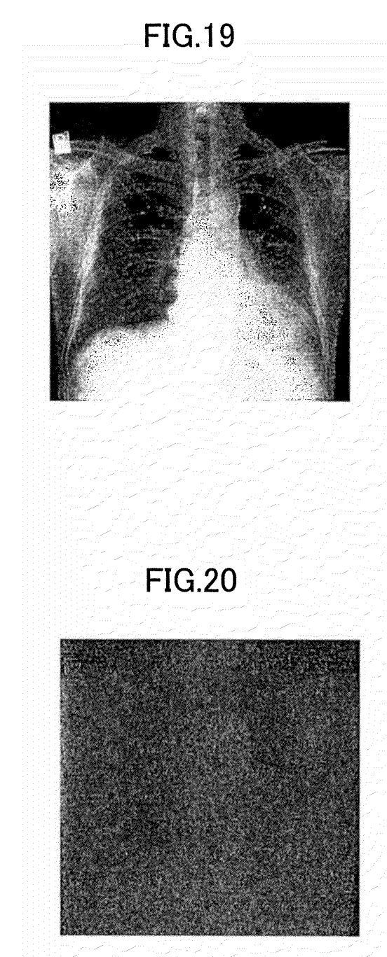

FIG. 19 is a diagram illustrating a display example of image data that is decompressed in the decompression processing section. FIG. 19 illustrates an image of the date obtained by applying the decompression processing to the compressed data in which data of radiographic image of the chest is compressed.

When the external storage media P1, P2 in which the correct replacement rule is stored is connected to the medium reading section 43 and the data is decoded with the re-replacement table generated by the replacement of this replacement rule, the image data before the compression is complete restored. Therefore, as illustrated in FIG. 19, a clear image is obtained, allowing determination of a sick portion in the radiographic image of the chest.

Next, a case in which a correct replacement rule is not obtained will be explained. For example, when a person who does not have the external storage media P1, P2 operates the system controller 4 or when a fake external storage medium in which a correct replacement rule is not stored is connected to, the decompression processing section may not obtain the correct replacement rule.

For example, when a replacement rule is not read out from the external storage media P1, P2, the L-table replacement section 565 and the H-table replacement section 575 do not perform the replacement for the replacement table, and instead, directly supply the replacement table obtained from the frame as a re-replacement table.

In this case, the Huffman table, namely, the re-replacement table used for the encoding in the L-plane decompression section 56 and the H-plane decompression section 57 illustrated in FIG. 3 is identical with the replacement table illustrated in FIG. 17, yet different from the table used for the encoding (see FIG. 16) in that the correspondence from the 6th to the 256th is different. Therefore, the image data before the compression is not completely restored. However, in the re-replacement table, the correspondence from the 1st to the 5th in which a frequency of access for reference is large at the time of conversion matches with that in the table used for the encoding. Therefore, a state of the image data before the compression is restored not even perfectly, but to a degree where a type of the image and its outline may be determined.

FIG. 20 is a diagram illustrating a display example of image data that is decompressed when a replacement rule is not obtained. FIG. 20 illustrates, similarly to FIG. 19, an image of the date obtained by performing the decompression processing to the compressed data in which data of radiographic image of the chest is compressed.

When the replacement rule is not obtained, although a clear image that allows determination of a sick portion is not obtained, an image is obtained with the sharpness to such an extent that the type of the image is radiographic image of chest. Therefore, for example, when a person who is not a medical doctor displays or processes the image data, a sick portion that is personal information of a patient is protected so as not to be seen by the person and further, since the type of the image is recognizable, handling of the image data is performed without failure.

In this way, according to the radiographic image diagnosis system S in the present embodiment, if the replacement table different from the corresponding table used for the encoding is transferred and if decoding is performed simply based on this replacement table, data is not restored to a state before the encoding, therefore, even if the image data is received by an outsider, it is not completely restored. On the other hand, if the external storage media P1, P2 (FIG. 1) is connected to the system controller 4 by a medical doctor or the like, a clear image may be obtained. In this way, information is protected by an encryption in a certain level. Moreover, since this encryption is made by generating a table in which corresponding counterpart is replaced with another counterpart included in the correspondence of the Huffman table, processing is uncomplicated. Therefore, it is possible to avoid slowdown in the processing necessary for transferring.

Although in the above-described embodiment, the difference based on whether or not the replacement rule is obtained is explained, it is also possible to divide a degree in which the replacement rule may be obtained into several stages to set stages of information disclosure. Subsequently, explanation will be made about a second embodiment in which stages are set for the degree in which the replacement rule may be obtained. In the following explanation of the second embodiment, the same elements as those in the previously described embodiment are denoted by the same numerals and the explanation will be made about different points from the previous embodiment.

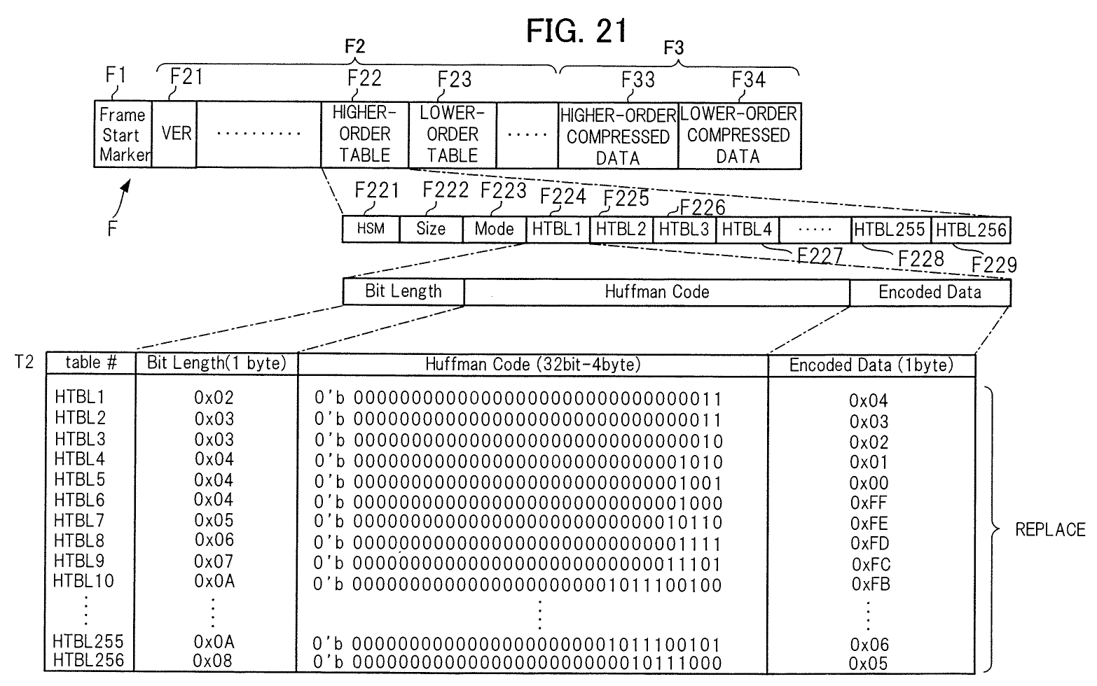

FIG. 21 is a diagram illustrating a structure of a frame generated by a frame integration section in the second embodiment and an example of a replacement table.

In the second embodiment, the H-table replacement section performs the replacement of numeric values also for the correspondence from the 1st to the 5th, in addition to the correspondence from the 6th to the 256th in the correspondence of the Huffman table. To be more specific, as illustrated in FIG. 17, the alignment of the 251 pieces of numeric values in the correspondence from the 6th to the 256th in the Huffman table is replaced in a reverse order, and furthermore, the alignment of numeric values in the correspondence from the 1st to the 5th in the Huffman table is replaced in a reverse order. In this way, the replacement is performed for most of the correspondence. This replacement is also the same for the L-table replacement section.

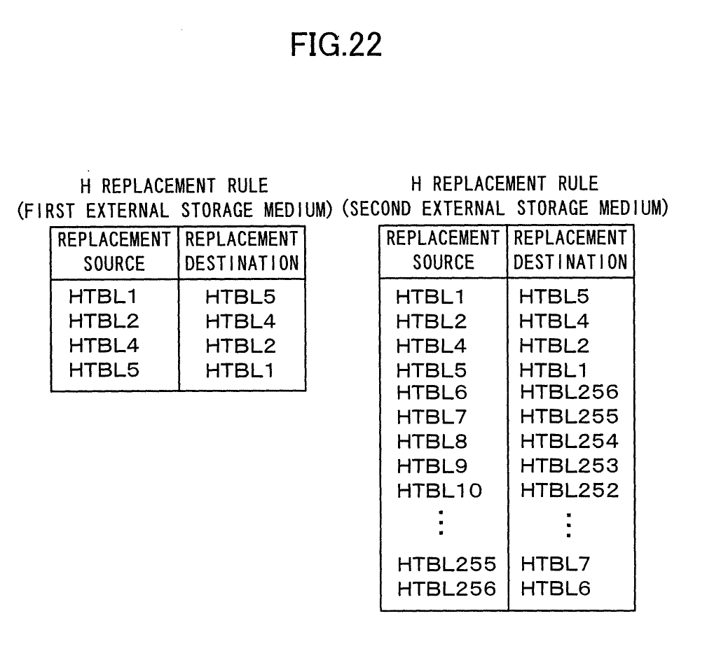

FIG. 22 is a diagram illustrating replacement rules stored in external storage media in the second embodiment.

In the second embodiment, replacement rules stored in the two external storage media P1, P2 illustrated in FIG. 1 are different from each other. Of the two external storage media P1, P2, the first external storage medium P1 is possessed by a work assistant, and the second external storage medium P2 is possessed by a medical doctor.

In the external storage medium P1, the H-replacement rule is stored for the correspondence from the 1st to the 5th as illustrated in FIG. 22 of the H-replacement table. In the external storage medium P2, the H-replacement rule is stored for the correspondence from the 6th to the 256th, in addition to the correspondence from the 1st to the 5th. In the second embodiment, similarly in the first embodiment, since the H-replacement rule and the L-replacement rule are the same, diagram and explanation of the L-replacement rule is omitted.

Since other configuration in the second embodiment is the same as those in the first embodiment, the diagrams referred to in the first embodiment are also used in the explanation.

In the second embodiment, for example, when a person who does not possess the external storage media P1, P2 operates the system controller 4, the decompression processing section 5 may not obtain the replacement rule. In such a case, the L-table replacement section 565 and the H-table replacement section 575 do not perform the replacement as to the replacement table and instead, directly supply the replacement table obtained from the frame as the re-replacement table. In this case, the Huffman table, namely, the re-replacement table used for the encoding in the L-plane decompression section 56 and the H-plane decompression section 57 is identical to the replacement table illustrated in FIG. 21 whereas most of the correspondence is different from that in the table used for the encoding (see FIG. 16). Therefore, the image data before the compression is not restored.

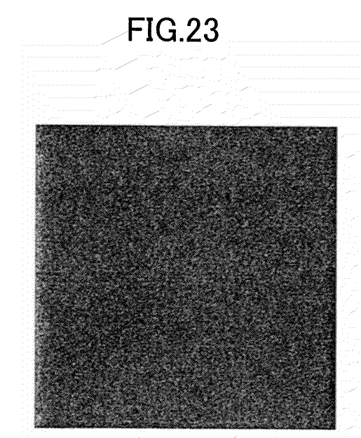

FIG. 23 is a diagram illustrating a display example of image data that is decompressed when the replacement rule is not obtained in the second embodiment.

When the replacement rule is not obtained in the second embodiment, a table used for decoding is mostly different from the table used for encoding. Therefore, the image data before the compression is not restored and presented like an image illustrated in FIG. 23, to an extent where even the type of the image may not be determined.

Here, for example, if the first external storage media P1 possessed by the work assistant is connected to the system controller 4, then according to the H-replacement rule stored in the first external storage media illustrated in FIG. 22, the replacement in the replacement table is performed. As a result, the correspondence from the 1st to the 5th in the re-replacement table becomes the same as the one used for the encoding and results in, for example, a state similar to, for example, the Huffman table illustrated in FIG. 17. Since in the re-replacement table, the correspondence from the 1st to the 5th in which a frequency of access for reference is large in the conversion matches with that used for the encoding, although a state of the image data before the compression is restored not perfectly, but still to the extent where a type of the image and its outline may be determined.

Also, for example, when the second external storage media P2 possessed by a medical doctor is connected to the system controller 4, then according to the H-replacement rule stored in the second external storage media illustrated in FIG. 22, the replacement in the replacement table is performed. As a result, all the correspondence from the 1st to the 256th in the re-replacement table matches with the one used for the encoding, thereby resulting in a similar state to the Huffman table illustrated in FIG. 16. The image data before the compression is completely restored. Therefore, as illustrated in FIG. 19, it is possible to obtain a clear image that allows determination of a sick portion in the radiographic image of chest.

In the above-described embodiments, the description is made for the case in which the reversible encoding compression is performed in the compression processing section, however the invention is also applicable to lossy, namely, a case in which an irreversible encoding compression is performed.

Subsequently, a third embodiment that performs an irreversible compression will be explained. In the following explanation of the third embodiment, the same elements as those in the previously described embodiments are denoted by the same numerals and the explanation will be made about different points from the previous embodiments.

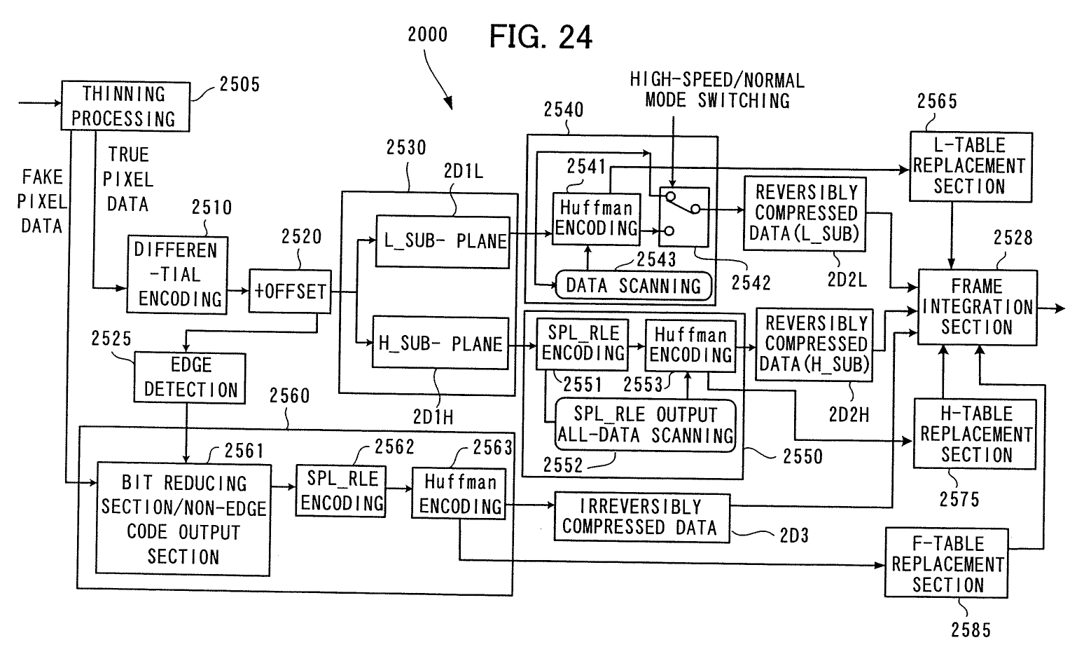

FIG. 24 is a diagram illustrating a compression processing section in the third embodiment.

A compression processing section 2000 in FIG. 24 is a section to compress image data by using an irreversible compression and a data compression is performed at a high compression ratio.

The compression processing section 2000 includes a thinning processing section 2505 to thin out TRUE pixels to be targeted to the reversible compression processing from all pixels making up an image represented by an image data, and as each section to perform an irreversible compression processing for FAKE pixels remaining after the TRUE pixels are thinned and to target for the irreversible compression processing, a FAKE-pixel-data compression section 2560 and an edge detection section 2525 are provided. Furthermore, in the compression processing section 2000, as each section to perform the reversible compression processing for the TRUE pixels, a second differential encoding section 2510, a second offset section 2520, a second plane division section 2530, a second L-plane compression section 2540 and a second H-plane compression section 2550 are provided. Moreover, in the compression processing section 2000, a L-table replacement section 2565, a H-table replacement section 2575 and a frame integration section 2528 are also provided.

The compression processing in the compression processing section 2000 illustrated in FIG. 24 will be described.

When image data is inputted into the compression processing section 2000, by the thinning processing section 2505, the data is divided into pixel data of the TRUE pixels targeted for the reversible compression processing and pixel data of the FAKE pixels targeted for the irreversible compression processing.

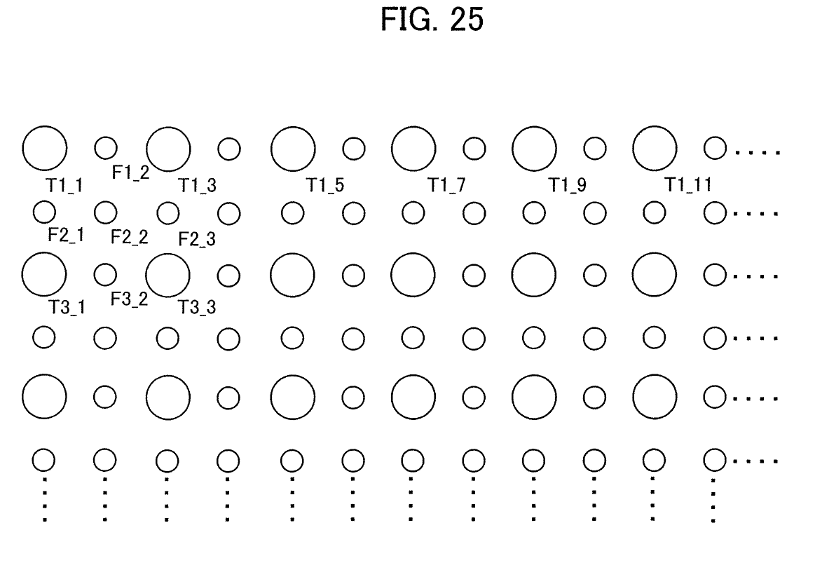

FIG. 25 is a diagram illustrating a concept of the thinning processing performed in the thinning processing section in FIG. 24.

FIG. 25 also illustrates a data structure of the image data.

In FIG. 25, the lateral direction of FIG. 25 is the main scanning direction, and the direction orthogonal to the main scanning direction is the sub-scanning direction. As described earlier, a row in which pixels are aligned along the main scanning direction is referred as the line, and pixels for the six lines are illustrated here. In FIG. 25, the position of each pixel is expressed by a subscript added to codes T and F each representing a pixel value. For example, in the third line, subscripts of 3_{—}1, 3_{—}2, 3_{—}3, 3_{—}4, . . . are sequentially added to the respective pixel values aligned in the main scanning direction.

The image data made up of the pixel values aligned in this manner is inputted into the thinning processing section 2505, and the thinning processing section 2505 classifies the respective pixels into the TRUE pixels and the FAKE pixels. The TRUE pixels among the pixels illustrated in FIG. 25 are each denoted by the code T, whereas the FAKE pixels among the pixels are each denoted by the code F. The TRUE pixels are periodically thinned out from the alignment of the pixels, and this diagram illustrates that in every other line (odd-numbered line) along the sub-scanning direction, every other TRUE pixel (odd-numbered pixel) along the main scanning direction is thinned out as the TRUE pixel. As a result, the TRUE pixels are equivalent to pixels of an image whose resolution is down to a half of the original resolution, and the pixels corresponding to a quarter of the pixels of the original image data are thinned out. The TRUE pixels thinned out in this manner form TRUE pixel data made up of a series of such TRUE pixels, and the TRUE pixel data has such a structure that the pixels are aligned in the main scanning direction and the sub-scanning direction, similar to the original image data. Also, the FAKE pixels left by thinning out the TRUE pixels form FAKE pixel data made up of a series of the FAKE pixels. This FAKE pixel data is targeted for the irreversible compression processing, while the TRUE pixel data is targeted for the reversible compression processing.

The pixel data of the TRUE pixels is subjected to processing that is similar to the reversible compression processing in the reversible compression processing section 2 described with reference to FIG. 2, by the second differential encoding section 2510, the second offset section 2520, the second plane division section 2530, the second L-plane compression section 2540 and the second H-plane compression section 2550 in the reversible compression processing section 2000. That is, in the second differential encoding section 2510, second differential encoding processing similar to the one performed by the differential encoding section 2510 is performed, the image data is inputted into the offset section 2520, and offset by a predetermined amount. Then, in the second plane division section 2530, the image data is divided into the lower-order sub-plane 2D1L made up of consecutive numeric values in lower-order bit and the higher-order sub-plane 2D1H made up of consecutive numeric values in higher-order bit, which are inputted into the second L-plane compression section 2540 and the second H-plane compression section 2550, respectively. The second L-plane compression section 2540 and the second H-plane compression section 2550 have structures similar to those of the L-plane compression section 26 and the H-plane compression section 27 illustrated in FIG. 2, respectively. For example, the second L-plane compression section 2540 also includes a Huffman encoding section 2541, a mode switching section 2542, and a data scanning section 2543. By these sections, processing similar to the one performed by the L-plane compression section 26 illustrated in FIG. 2 is performed and a lower-order compressed data 2D2L is outputted. On the other hand, the second H-plane compression section 2550 includes a run-length encoding section 2551, a data scanning section 2552, and a Huffman encoding section 2553, and by these sections, processing similar to the one performed by the H-plane compression section 27 in FIG. 2 is performed and a higher-order compressed data 2D2H is outputted.

In contrast, the image data of the FAKE pixels is subjected to the irreversible compression processing by the FAKE-pixel-data compression section 2560. This FAKE-pixel-data compression section 2560 includes a bit reducing/non-edge code output section 2561, a run-length encoding section 2562, and a Huffman encoding section 2563. Numeric values included in the FAKE pixel data are replaced with, by the bit reducing/non-edge code output section 2561, either non-edge codes or numeric values expressed by the number of bits equal to or smaller than the number of unit bit of the original data. Here, in the bit reducing/non-edge code output section 2561, whether the numeric values included in the FAKE pixel data outputs a non-edge code or a numeric value expressed in smaller number of bits that is equal to or less than the number of bit unit of the original data is determined based on whether or not the FAKE pixel having the pixel value of the numeric value in interest is a pixel belonging to an edge portion of the image. The determination as to whether or not the FAKE pixel belongs to the edge portion is made by the edge detection section 2525. In the following, explanation is made by a concrete example in which the numeric value expressed in smaller bits is defined as 4-bit data and the non-edge code is defined as 1-bit data.

Based on the determination by the edge detection section 2525, in the bit reducing/non-edge code output section 2561, a pixel value of the pixel belonging to the edge portion of the image is replaced with a 4-bit code, and a pixel value of the pixel not belonging to the edge portion is replaced with a 1-bit code. The data replaced with a 1-bit code or a 4-bit code is subjected to the exactly same processing as that in the H-plane compression section 27 illustrated in FIG. 3, by the run-length encoding section 2562 and the Huffman encoding section 2563. Here, the FAKE-pixel-data compression section 2560 also includes a data scanning section that functions similarly to the data scanning section 272 of the H-plane compression section 27 in FIG. 2, but its illustration is omitted. The FAKE pixel data after being subjected to the run-length encoding processing and the Huffman encoding processing is outputted from the FAKE-pixel-data compression section 2560 as an irreversibly compressed data 2D3.

Next, the irreversible compression processing for the FAKE pixel data will be described. The FAKE pixel data obtained by the thinning processing section 2505 is inputted into the FAKE-pixel-data compression section 2560. The bit reducing/non-edge code output section 2561 in the FAKE-pixel-data compression section 2560 outputs either a code indicating that the FAKE pixel data is not an edge portion or a numeric value expressed by the number of bits equal to or smaller than the number of unit bit of the original data, depending on whether or not the FAKE pixel data is of an edge portion. Whether the FAKE pixel data is of the edge portion or not is determined by the edge detection section 2525 in FIG. 24, based on a difference of data after the offset by the second offset section 2520.

In the following, how the FAKE pixel data is encoded will be described.

When the pixel value of the TRUE pixel illustrated in FIG. 25 is expressed by Tn_k, the pixel value of the FAKE pixel adjacent to this TRUE pixel is expressed by Fn_k+1, Fn+1_k, Fn+1_k+1, . . . . The pixel value of another TRUE pixel at a position over the FAKE pixel adjacent to the TRUE pixel is expressed by Tn_k+2, Tn+2_k, Tn+2_k+2, . . . . In the edge detection section 2525, when a differential value obtained by the two-dimensional differential encoding processing from these four TRUE pixels' pixel values Tn_k, Tn_k+2, Tn+2_k and Tn+2_k+2 (here, not a difference value expressed by the numeric value from “00” to “FF” in hexadecimal notation as described above, but a difference value obtained by directly acquiring a difference of the pixel values and expressed in decimal notation) belongs to a domain bellow (−L) or a domain equal to or above (+L) defined by using a positive integer-value threshold parameter L set in the edge detection section 2525, the above-mentioned three FAKE pixels' pixel values Fn_k+1, Fn+1_k and Fn+1_k+1 are determined to be the pixel values at an edge portion and each encoded into a 4-bit code starting from “1” by the bit reducing/non-edge code output section 2561.

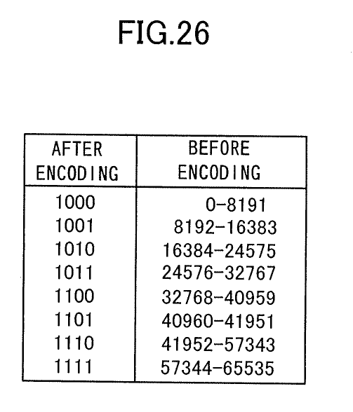

FIG. 26 is a diagram illustrating an encoding mode of encoding into a 4-bit code.

In this encoding mode, if the number of unit bit of the original data representing the pixel value is 16, the pixel value of the FAKE pixel is encoded into a code of “1000”-“1111” by cutting off lower-order 13 digits of the 16-bit value and adding “1” to the head of the remaining higher-order 3 digits. Thus, as illustrated in the list of this diagram, among the numeric values “0”-“65535” before the encoding, the numeric values “0”-“8191” are encoded into “1000”, and the numeric values “8192”-“16383” are encoded into “1001”. Similarly, the numeric values “16384”-“24575”, “24576”-“32767”, “32768”-“40959”, “40960”-“41951”, “41952”-“57343” and “57344”-“65535” are encoded into “1010”, “1011”, “1100”, “1101”, “1110” and “1111”, respectively. Such encoding mode is obtained by a significantly simple processing of cutting off digits of a bit value. By such encoding into the 4-bit code, the information of the original image is maintained to some extent, avoiding deterioration of the image quality.

In the edge detection section 2525, when the difference value obtained from the above-mentioned four TRUE pixels' pixel values Tn_k, Tn_k+2, Tn+2_k and Tn+2_k+2 by the two-dimensional differential encoding processing belongs to a domain of not less than (−L) and not more than (+L), the above-mentioned three FAKE pixels' pixel values Fn_k+1, Fn+1_k and Fn+1_k+1 are determined not to be the pixel values at an edge portion and encoded into a 1-bit code “0” in the bit reducing/non-edge code output section 2561.

The data replaced with the 1-bit or 4-bit code is subjected, by the run-length encoding section 2562 and the Huffman encoding section 2563, to the processing that is exactly same as the above-described processing in the H-plane compression section 27 illustrated in FIG. 2. Here, the FAKE-pixel-data compression section 2560 also includes a data scanning section that functions like the data scanning section 272 of the H-plane compression section 27 illustrated in FIG. 2, but its illustration is omitted in FIG. 24. The FAKE pixel data after being subjected to the run-length encoding processing and the Huffman encoding processing is outputted from the FAKE-pixel-data compression section 2560 as the irreversibly compressed data 2D3.

In the compression processing section 2000, the Huffman table used for the encoding in the Huffman encoding section 2541 is inputted into the L-table replacement section 2565. Also, the Huffman table used for the encoding in the Huffman encoding section 2553 is inputted into the H-table replacement section 2585. Furthermore, the Huffman table used for the encoding in the Huffman encoding section 2563 is inputted into a F-table replacement section 2585. In the L-table replacement section 2565, the H-table replacement section 2575 and the F-table replacement section 2585, similarly to the L-table replacement section 265 and the H-table replacement section 275 illustrated in FIG. 2, a corresponding counterpart in the correspondence is replaced with another counterpart included in the correspondence in the respective Huffman tables.

A group made up of the lower-order compressed data 2D2L and the higher-order compressed data 2D2H outputted by the second L-plane compression section 2540 and the second H-plane compression section 2550, respectively, and the further added irreversibly compressed data 2D3 forms the compressed data obtained by subjecting the original image data to the irreversible compression processing in the compression processing section 2000. This compressed data is inputted into the frame integration section 2528.

The frame integration section 2528 combines the lower-order compressed data 2D2L, the higher-order compressed data 2D2H and the irreversibly compressed data 2D3 to generate a frame. An replacement table generated by being replaced in the L-table replacement section 2565, the H-table replacement section 2585 and the F-table replacement section 2585 is inserted into the header of the frame.

The frame is transmitted to the system controller 4 (see FIG. 1) and subjected to the decompression processing by the decompression processing section 5. The decompression processing section 5 in the third embodiment performs decompression processing reverse to the compression processing section 2000 explained with reference to FIG. 24 through FIG. 26 to generate image data. The decompression processing section has a mirror image structure of the compression processing section 2000 illustrated in FIG. 24, like the relationship between the compression processing section and the decompression processing section in the first embodiment, therefore its illustration and detailed explanation are omitted. However, also in the third embodiment, for complete restoration of the image data before being subjected to the compression processing, it is necessary that the external storage medium is connected and the correct replacement rule is read out. If the correct replacement rule is not read out, clear image data is not obtained, similarly to the first embodiment.

Additionally, in the above-described embodiments, the radiographic image diagnosis system S is explained as an example of the data transfer system according to the invention, however the invention is not limited to this.

The data transfer system according to the invention may be applied to a display system that connects facilities such as hospitals via a network such as the Internet.

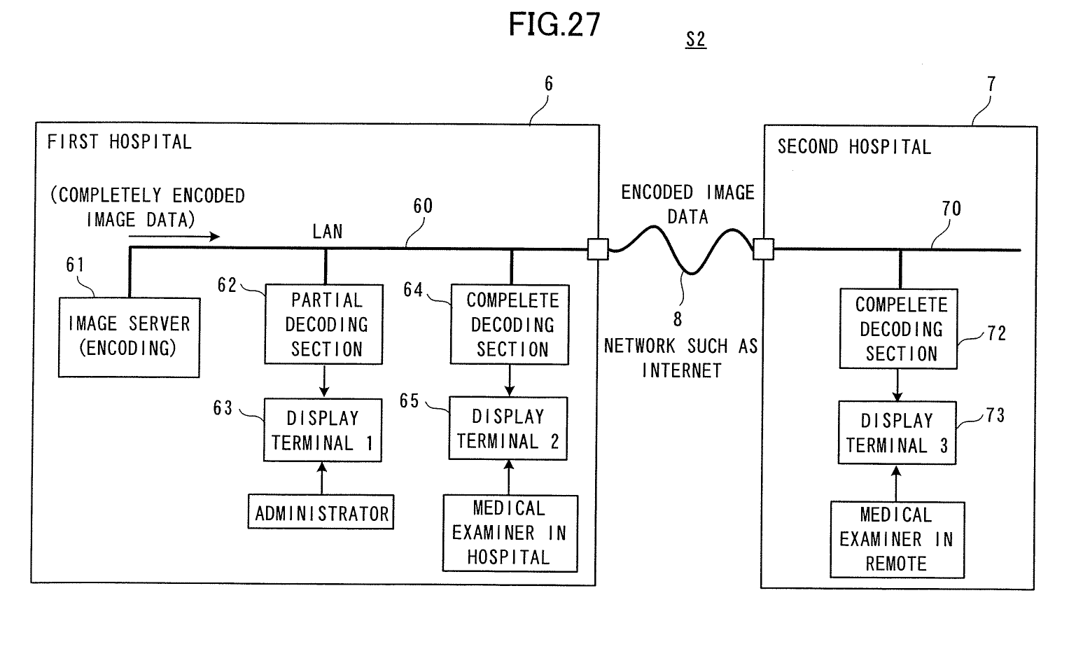

FIG. 27 is a block diagram illustrating a medical image transfer system via a network, which is a fourth embodiment according to the invention.

A medical image transfer system S2 in FIG. 27 includes a first system 6 provided in a first hospital and a second system 7 provided in a second hospital at a distant location from the first hospital 1.

The first system 6 includes an image server 61, a partial decoding section 62, a first display terminal 63, a complete decoding section 64, and a second display terminal 65.

The image server 61 incorporates a not-illustrated compression processing section similar to the compression processing section 2 in FIG. 1, and stores an radiographic image after applying compression processing to the radiographic image. That is, the image data stored in the image server 61 is already subjected to the encoding processing explained with reference to FIG. 2 through FIG. 21, and includes a replacement table in which a part of the Huffman table is replaced. Incidentally, the image server 61 may be, for example, an apparatus which is separate from the radiography detection unit 3 and capable of communicating with the radiography detection unit 3, and which receives an image after being subjected to the compression processing in the radiography detection unit 3 and stores the image.

Each of the partial decoding section 62 and the complete decoding section 64 is connected to the image server 61, respectively, via a LAN (Local Area Network) 60 deployed in the first hospital. The partial decoding section 62 and the display terminal 63 connected to this partial decoding section 62 are used by an office administrator in the first hospital. In addition, the complete decoding section 64 and the display terminal 65 connected to this complete decoding section 64 are used by a person who diagnoses such as a medical doctor by seeing a radiographic image. The respective configuration of the partial decoding section 62 and the complete decoding section 64 are different from the system controller 4 in FIG. 1 in that the source control section 46 is not provided and instead of the display section 44, the display terminals 63, 65 are externally connected. Furthermore, in the partial decoding section 62 and the complete decoding section 64, a not-illustrated storage medium in which the replacement rule is stored is already provided, and the partial decoding section 62 and the complete decoding section 64 hold the replacement rule. Other configurations are similar to those of the system controller 4 in FIG. 1. As the replacement rule, the partial decoding section 62 holds a replacement rule such as the one illustrated on the left side of FIG. 22, about the correspondence from the first to the fifth, whereas the complete decoding section 64 holds, in addition to the correspondence from the first to the fifth, a replacement rule for the correspondence from the 6th to the 256th such as the one illustrated on the left side of FIG. 22.

The second system 7 includes a complete decoding section 72 and a third display terminal 75. The complete decoding section 72 also has the same configuration as that of the complete decoding section 64 in the first system 6. The complete decoding section 72 and the third display terminal 75 connected to the complete decoding section 72 are used by a person who diagnoses in the second hospital at a distant location. The complete decoding section 72 is connected to a LAN 70 deployed in the second hospital, and the LAN 70 is connected to the LAN 60 in the first hospital via a network 8. The network 8 is the Internet, for example, and for example, a dedicated line or a private network may be employed as well.

The partial decoding section 62, the complete decoding section 64 and the complete decoding section 72 read out encoded image data from the image server 61 according to the operation of each user and perform decoding processing.

In the partial decoding section 62, by the replacement rule illustrated on the left side in FIG. 22, the replacement of the replacement table is performed. As a result, in the Huffman table used for the decoding (re-replacement table), the correspondence from the first to the fifth where a frequency of access for reference is large at the time of conversion matches the one used for the encoding, so that although a state of the image data before the compression is not perfectly restored, for example, as illustrated in FIG. 20, the state of the image data is restored to the extent where a type of the image and its outline may be determined, and displayed on the first display terminal 63.

The complete decoding sections 64, 72 perform the replacement for the replacement table, according to the complete replacement rule illustrated on the right side in FIG. 22. As a result, all the correspondence from the 1st to the 256th in the re-replacement table used for decoding matches the one used for encoding, so that the image data before the compression is completely restored. Therefore, as illustrated in FIG. 19, a clear image allowing determination of a sick portion in the radiographic image of the chest is obtained, and displayed on the second display terminal 65 and the third display terminal 73.

In this way, the contents of data transferred over the LAN 60, 70 in the hospitals and the network 8 outside the hospitals are protected. Accordingly, it is possible to set a level of protection for each user.

The medial image transfer system has been explained as an example of the data transfer system according to the invention. However, the data transfer system according to the invention is not limited to the radiographic image diagnosis system S and the medial image transfer system and, for example, may be a shooting and display system provided with a digital camera and a display unit.

In the above-described embodiments, as an example of the encoding section according to the invention, the encoding section that performs the Huffman encoding to the data after being subjected to the encode processing is described. However, the invention is not limited to this and may be one that performs the Huffman encoding to the data after being subjected to discrete cosine transformation.

Further, in the above-described embodiments, description is made about the example in which the optimization of the Huffman table is performed by the data scanning section according to a frequency of occurrence. However, the invention is not limited to this and, for example, the correspondence table may be a fixed table prepared beforehand.

What is claimed is:

1. A data transfer system, comprising:
a transmitting apparatus that transmits data; and
a receiving apparatus that receives the data transmitted by the transmitting apparatus,
wherein the transmitting apparatus comprises:
an encoding section that is supplied with to-be-converted data, converts the data into a code by using a correspondence table in which one-to-one correspondence between a plurality of data values and a plurality of codes is described and generates encoded data;
a replacement table generating section that, for at least a part of the correspondence described in the correspondence table used by the encoding section, replaces a corresponding counterpart with another counterpart included in the correspondence, and generates a replacement table; and
a transmitting section that transmits a group of data in which the encoded data generated by the encoding section and the replacement table generated by the replacement table generating section are combined, and wherein the receiving apparatus comprises:
a receiving section that receives the group of data transmitted by the transmitting section;
a re-replacement table generating section into which a replacement rule for replacing a corresponding counterpart in one-to-one correspondence between a plurality of data values and a plurality of codes with another counterpart included in the correspondence is inputted, and which replaces, according to the replacement rule, the corresponding counterpart in the correspondence described in the replacement table in the group of data received by the receiving section, and generates a re-replacement table; and
a decoding section that decodes the encoded data in the group of data received by the receiving section to a data value by using the re-replacement table generated by the re-replacement table generating section.

2. The data transfer system according to claim 1, wherein the re-replacement table generating section replaces the corresponding counterpart with the another counterpart for a portion in which a frequency of access for reference at the time of conversion is lower than that in another portion, in the correspondence described in a correspondence table used by the encoding section, and generates a replacement table.

3. The data transfer system according to claim 1, wherein the transmitting apparatus comprises a compression section which compresses data, the compression section either including the encoding section or being separate from the encoding section.

4. The data transfer system according to claim 1, wherein
the transmitting apparatus further comprises:
a differential generating section that determines a difference between numeric values adjacent to each other directly or with a certain space therebetween, for consecutive numeric values of to-be-compressed data made up of consecutive numeric values, and generates new to-be-compressed data made up of consecutive numeric values each representing the difference;
an offset section that offsets each numeric value of the new to-be-compressed data generated by the differential degeneration section by a predetermined value;
a division section that divides each of numeric values of the to-be-compressed data which are offset by the offset section into a higher-order bit portion and a lower-order bit portion, at a predetermined division bit number smaller than the predetermined unit bit number, so as to divide the to-be-compressed data into higher-order data made up of a series of the higher-order bit portions of the respective numeric values and lower-order data made up of a series of the higher-order bit portions of the respective numeric values; and
a higher-order-data compression section that subjects the higher-order data obtained as a result of the division by the division section to reversible compression processing, and
the encoding section plays a role of at least a part of the reversible compression processing in the higher-order-data compression section.

5. The data transfer system according to claim 4, wherein
the higher-order-data compression section further comprises a consecutive encoding section that directly outputs, with respect to numeric values except one or a plurality of predetermined to-be-compressed numeric values in the higher-order data, the numeric values as they are, and that encodes, with respect to the to-be-compressed numeric value, the to-be-compressed numeric values to the to-be-compressed numeric value and a numeric value representing the number of consecutive pieces of a to-be-compressed numeric value that is identical to the to-be-compressed numeric value to be outputted, and
the encoding section is an entropy encoding section that subjects the data after being encoded in the consecutive encoding section to entropy encoding by using the correspondence table.

6. The data transfer system according to claim 4, wherein
the higher-order-data compression section further comprises a consecutive encoding section that directly outputs, with respect to numeric values except one or a plurality of predetermined to-be-compressed numeric values in the higher-order data, the numeric values as they are, and that encodes, with respect to the to-be-compressed numeric value, the to-be-compressed numeric values to the to-be-compressed numeric value and a numeric value representing the number of consecutive pieces of a to-be-compressed numeric value that is identical to the to-be-compressed numeric value to be outputted, and
the encoding section is a Huffman encoding section that subjects the data after being encoded in the consecutive encoding section to Huffman encoding by using a Huffman table as the correspondence table.

7. The data transfer system according to claim 4, wherein the higher-order-data compression section further comprises:
a consecutive encoding section that directly outputs, with respect to numeric values except one or a plurality of predetermined to-be-compressed numeric values in the higher-order data, the numeric values as they are, and that encodes, with respect to the to-be-compressed numeric value, the to-be-compressed numeric values to the to-be-compressed numeric value and a numeric value representing the number of consecutive pieces of a to-be-compressed numeric value that is identical to the to-be-compressed numeric value to be outputted;
a histogram calculation section that obtains a histogram of a numeric value which occurs in the data after being encoded in the consecutive encoding section; and
a code assignment section that allocates, in a table which associates a code with a numeric value, the code having a shorter code length for the numeric value having a higher frequency of occurrence, based on the histogram obtained by the histogram calculation section, and
the encoding section is an entropy encoding section that subjects the data after being encoded in the consecutive encoding section to entropy encoding by using the table in which the code is allocated in the code assignment section as the correspondence table.

8. The data transfer system according to claim 4, wherein
the transmitting apparatus further comprises a lower-order-data compression section that subjects the lower-order data divided by the division section to reversible compression processing, and
the encoding section plays a role of at least a part of the reversible compression processing in the lower-order-data compression section.

9. The data transfer system according to claim 8, wherein the encoding section subjects the lower-order data to entropy coding by using the correspondence table.

10. The data transfer system according to claim 8, wherein the encoding section subjects the lower-order data to Huffman encoding by using a Huffman table as the correspondence table.

11. The data transfer system according to claim 8, wherein the lower-order-data compression section outputs the lower-order data without compression in respond to an instruction to omit compression.

12. A transmitting apparatus comprising:
an encoding section that is supplied with to-be-converted data, converts the data into a code by using a correspondence table in which one-to-one correspondence between a plurality of data values and a plurality of codes is described and generates encoded data;
a replacement table generating section that, for at least a part of the correspondence described in the correspondence table used by the encoding section, replaces a corresponding counterpart with another counterpart included in the correspondence, and generates a replacement table; and
a transmitting section that transmits a group of data in which the encoded data generated by the encoding section and the replacement table generated by the replacement table generating section are combined.

13. A receiving apparatus comprising:
a receiving section that receives a group of data in which a correspondence table where one-to-one correspondence between a plurality of data values and a plurality of codes is described and encoded data of a series of the codes are combined;
a receiving-side re-replacement table generating section into which a replacement rule for replacing a corresponding counterpart in the one-to-one correspondence between a plurality of data values and a plurality of codes with another counterpart included in the correspondence is inputted, and which replaces, according to the replacement rule, the corresponding counterpart in the correspondence described in the replacement table in the group of data received by the receiving section, and generates a receiving-side re-replacement table; and
a decoding section that decodes the encoded data in the group of data received by the receiving section to a data value by using the receiving-side re-replacement table generated by the receiving-side re-replacement table generating section.

14. A radiographic image transfer system comprising:
a radiation detection unit that receives radiation emitted from a radiation source and passing through a to-be-diagnosed subject and transmits data representing an image by the radiation; and
a data receiving unit that receives the data transmitted from the radiation detection unit and performs processing,
wherein the radiation detection unit comprises:
an encoding section that is supplied with to-be-converted data, converts the data into a code by using a correspondence table in which one-to-one correspondence between a plurality of data values and a plurality of codes is described, and generates encoded data;
a replacement table generating section that, for at least a part of the correspondence described in the correspondence table used by the encoding section, replaces a corresponding counterpart with another counterpart included in the correspondence, and generates a replacement table; and
a transmitting section that transmits a group of data in which the encoded data generated by the encoding section and the replacement table generated by the replacement table generating section are combined, and
wherein the data receiving unit comprises:
a receiving section that receives the group of data transmitted by the transmitting section;
a re-replacement table generating section into which a replacement rule for replacing a corresponding counterpart in one-to-one correspondence between a plurality of data values and a plurality of codes with another counterpart included in the correspondence is inputted, and which replaces, according to the replacement rule, the corresponding counterpart in the correspondence described in the replacement table in the group of data received by the receiving section, with another counterpart, thereby generating a re-replacement table; and
a decoding section that decodes the encoded data in the group of data received by the receiving section to a data value by using the re-replacement table generated by the re-replacement table generating section.

15. A radiographic image diagnosis system comprising:
a radiation detection unit that receives radiation emitted from a radiation source and passing through a to-be-diagnosed subject and transmits data representing an image by the radiation; and
a data processing unit that receives the data transmitted from the radiation detection unit and performs processing for diagnosis,
wherein the radiation detection unit comprises:
an encoding section that is supplied with to-be-converted data and converts the data into a code by using a correspondence table in which one-to-one correspondence between a plurality of data values and a plurality of codes is described, and generates encoded data;
a replacement table generating section that, for at least a part of the correspondence described in the correspondence table used by the encoding section, replaces a corresponding counterpart with another counterpart included in the correspondence, and generates a replacement table; and
a transmitting section that transmits a group of data in which the encoded data generated by the encoding section and the replacement table generated by the replacement table generating section are combined, wherein the data processing unit comprises:
a receiving section that receives the group of data transmitted by the transmitting section;
a re-replacement table generating section into which a replacement rule for replacing a corresponding counterpart in one-to-one correspondence between a plurality of data values and a plurality of codes with another counterpart included in the correspondence is inputted, and which replaces, according to the replacement rule, the corresponding counterpart in the correspondence described in the replacement table in the group of data received by the receiving section, with another counterpart, and generates a re-replacement table;
a decoding section that decodes the encoded data in the group of data received by the receiving section to a data value by using the re-replacement table generated by the re-replacement table generating section;
a diagnosis processing section that subjects the data generated by the decoding in the decoding section to diagnosis processing; and
a display section that displays an image represented by the data processed by the diagnosis processing section.
